(19) United States
(12) Patent Application Publication
(10) Pub. No.: US 2004/0172360 A1
(43) Pub. Date: Sep. 2, 2004

(54) Methods and systems for managing accounts payable

(76) Inventors: Sheila M. Mabrey, Fort Myers, FL (US); Carol U. Bass, Fort Myers, FL (US); Sherry A. Ryan, Fort Myers, FL (US); Carrie A. Nation, Fort Myers, FL (US); Amjad R. Hannoneh, Fort Myers, FL (US)

Correspondence Address: John S. Beulick, Armstrong Teasdale LLP, One Metropolitan Sq., Suite 2600, St. Louis, MO, 63102, US

(21) Appl. No.: 10/376,723

(22) Filed: Feb. 28, 2003

(51) Int. Cl. G06F 17/60

(52) U.S. Cl. 705/40

(57) ABSTRACT

A method for managing accounts payable for a business using a server system is provided. The server system is coupled to a centralized database and at least one client system. The method includes receiving at the server system accounts payable (AP) information for the business from the client system wherein AP information includes at least one of invoices and purchase orders relating to the business, storing the AP information received at the server system in the centralized database, authorizing a user to access the AP information based on a profile of the user, updating the centralized database periodically with newly received AP information to maintain the AP information, processing the AP information stored in the centralized database, and utilizing a payment accelerator module to facilitate expedited payment of invoices satisfying a payment accelerator criteria.

### BACKGROUND OF THE INVENTION

This invention relates generally to managing accounts payable and, more particularly, to network-based methods and systems for managing accounts payable.

The accounting department of a business entity expends substantial resources managing accounts payable. Accounts payable, also known as “trade payables,” are liabilities that represent obligations arising from the normal business activity of buying goods or services “on invoice” as distinguished from, for example, cash-on-delivery transactions. Accounts receivable, also known as “trade receivables,” are claims to cash resulting from such sale of goods or services “on invoice.” In connection with such “on-invoice” transactions, accounts receivables are in a sense the opposite of accounts payable. The former are reflected as assets on the supplier's balance sheet, the latter as liabilities on the buyer's.

An accounts payable function includes the tasks of processing invoices, matching invoices with purchase orders and receipts, approving invoices for payment, managing terms, paying invoices based on the terms, applying credits, and confirming payment of invoices. In addition to processing invoices and proper application of the payments, determining appropriate write-offs and appropriate reporting capabilities must also be managed. These tasks are time-consuming and often take away resources of the corporation from its operations and other profitable activities. Completing several of these tasks also typically requires interfacing with outside businesses.

When a supplier provides goods or services to a buyer on invoice, payment is ordinarily due a fixed number of days from the date of the invoice (e.g., 30 or 60 days) depending upon the arrangement between the buyer and supplier (i.e., the Invoice Due Date). It is not uncommon, however, for certain suppliers to be willing to provide an early payment discount to a buyer if a particular invoice is paid on a date that is either on or before a certain number of days after the invoice date, or on or before a certain number of days prior to the Invoice Due Date. For example, a supplier may be willing to provide a two (2) percent discount if an invoice is paid on or before ten (10) days after the invoice date.

### BRIEF DESCRIPTION OF THE INVENTION

In one aspect, a method for managing accounts payable for a business using a server system is provided. The server system is coupled to a centralized database and at least one client system. The method includes receiving at the server system accounts payable (AP) information for the business from the client system wherein AP information includes at least one of invoices and purchase orders relating to the business, storing the AP information received at the server system in the centralized database, authorizing a user to access the AP information based on a profile of the user, updating the centralized database periodically with newly received AP information to maintain the AP information, processing the AP information stored in the centralized database, and utilizing a payment accelerator module to facilitate expedited payment of invoices satisfying a payment accelerator criteria.

In another aspect, a method for managing accounts payable for a business using a server system is provided. The server system is coupled to a centralized database and at least one client system. The method includes receiving at the server system accounts payable (AP) information for the business from the client system wherein AP information includes at least one of invoices and purchase orders relating to the business, storing the AP information received at the server system in the centralized database, authorizing a user to access the AP information based on a profile of the user, updating the centralized database periodically with newly received AP information to maintain the AP information, processing the AP information stored in the centralized database including enabling a user to submit from the client system to the server system at least one invoice for processing and payment, utilizing a payment accelerator module to facilitate expedited payment of invoices satisfying a payment accelerator criteria, providing a payment accelerator notification page displayed on the client system for prompting a user to register at least one of a supplier and a user to receive notification based on a frequency selected of when at least one invoice satisfying the payment accelerator criteria is received at the server system, and providing a payment notification page displayed on the client system for notifying at least one of a user and a supplier that a payment has been made relating to an invoice satisfying a payment criteria.

In another aspect, a network based system for managing accounts payable for a business is provided. The system includes a client system having a browser, a centralized database for storing information, and a server system. The server system is configured to be coupled to the client system and the database. The server system is further configured to receive accounts payable (AP) information for the business from the client system wherein AP information includes at least one of invoices and purchase orders relating to the business, store the AP information in the centralized database, authorize a user to access the AP information based on a profile of the user, update the centralized database periodically with newly received AP information to maintain the AP information, process the AP information stored in the centralized database, and access a payment accelerator module to facilitate expedited payment of invoices satisfying a payment accelerator criteria.

In another aspect, a computer program embodied on a computer readable medium for managing accounts payable for a business is provided. The program includes a code segment that receives accounts payable (AP) information for the business and then maintains a database by adding, deleting and updating AP information wherein AP information includes at least one of invoices and purchase orders relating to the business. The code segment then provides users with access to AP information, authorizes users to access AP information based on a profile of the user, processes AP information stored in the database, and utilizes a payment accelerator module to facilitate expedited payment of invoices satisfying a payment accelerator criteria.

### BRIEF DESCRIPTION OF THE DRAWINGS

FIG. 1 is a simplified block diagram of An Accounts Payable Coordination System (APCS) in accordance with one embodiment of the present invention.

FIG. 2 is an expanded version block diagram of an example embodiment of a server architecture of the APCS.

FIG. 3 shows a configuration of a database within the database server of the server system including other related server components.

FIG. 4 is a flowchart of the processes employed by APCS to facilitate use.

FIG. 5 is an example embodiment of a user interface displaying a login page within an APCS.

FIG. 6 is an example embodiment of a user interface displaying a welcome page within an APCS.

FIG. 7 is an example embodiment of a user interface displaying an add/edit personal profile page within an APCS.

FIG. 8 is an example embodiment of a user interface displaying an add/edit personal profile page within an APCS.

FIG. 9 is an example embodiment of a user interface displaying a modify user profile page within an APCS.

FIG. 10 is an example embodiment of a user interface displaying an add business to profile page within an APCS.

FIG. 11 is an example embodiment of a user interface displaying an approval page within an APCS.

FIG. 12 is an example embodiment of a user interface displaying a buyer codes page within an APCS.

FIG. 13 is an example embodiment of a user interface displaying a confirmation page within an APCS.

FIG. 14 is an example embodiment of a user interface displaying an approval email within an APCS.

FIG. 15 is an example embodiment of a user interface displaying a common navigational bar and bulletin board utilized by an APCS.

FIG. 16 is an example embodiment of a user interface displaying a pending approval page within an APCS.

FIG. 17 is an example embodiment of a user interface displaying an administrator user profile page within an APCS.

FIG. 18 is an example embodiment of a user interface displaying an administer approvers page within an APCS.

FIG. 19 is an example embodiment of a user interface displaying a routing to a web invoicing page within an APCS.

FIG. 20 is an example embodiment of a user interface displaying a purchase order search page within an APCS.

FIG. 21 is an example embodiment of a user interface displaying a purchase order search result page within an APCS.

FIG. 22 is an example embodiment of a user interface displaying a purchase order details page within an APCS.

FIG. 23 is an example embodiment of a user interface displaying a select supplier remit page within an APCS.

FIG. 24 is an example embodiment of a user interface displaying a create invoice page within an APCS.

FIG. 25 is an example embodiment of a user interface displaying an upload attachments page within an APCS.

FIG. 26 is an example embodiment of a user interface displaying a confirm invoice actions page within an APCS.

FIG. 27 is an example embodiment of a user interface displaying an invoice details page within an APCS.

FIG. 28 is an example embodiment of a user interface displaying a purchase order search page using non-U.S. currency within an APCS.

FIG. 29 is an example embodiment of a user interface displaying a ship to details page within an APCS.

FIG. 30 is an example embodiment of a user interface displaying a confirm invoice page within an APCS.

FIG. 31 is an example embodiment of a user interface displaying a common navigational bar having a payment accelerator function included within an APCS.

FIG. 32 is an example embodiment of a user interface displaying a payment accelerator invoice search page within an APCS.

FIG. 33 is an example embodiment of a user interface displaying search results from a payment accelerator invoice search performed within an APCS.

FIG. 34 is an example embodiment of a user interface displaying multiple search results from a payment accelerator invoice search performed within an APCS.

FIG. 35 is an example embodiment of a user interface displaying invoices selected for acceleration within an APCS.

FIG. 36 is an example embodiment of a user interface displaying a supplier agreement page within an APCS.

FIG. 37 is an example embodiment of a user interface displaying an invoice details page for an invoice included within an APCS.

FIG. 38 is an example embodiment of a user interface displaying a payment accelerator notification page within an APCS.

FIG. 39 is an example embodiment of a user interface displaying an add payment accelerator notification contact page within an APCS.

FIG. 40 is an example embodiment of a user interface displaying a payment search page within an APCS.

FIG. 41 is an example embodiment of a user interface displaying a supplier search result page within an APCS.

FIG. 42 is an example embodiment of a user interface displaying a payment search result page within an APCS.

FIG. 43 is an example embodiment of a user interface displaying a payment notification page within an APCS.

### DETAILED DESCRIPTION OF THE INVENTION

Example embodiments of systems and processes that facilitate integrated network-based electronic reporting and workflow process management related to an Accounts Payable Coordination System (APCS) are described below in detail. A technical effect of the systems and processes described herein include at least one of facilitating an electronic submission of information using a client system, automating extraction of information, and web-based reporting for internal and external system users. The APCS allows a business having accounts payable to register within the system, and then collect, manage, store and disseminate accounts payable (AP) information among internal users and selected outside users-to facilitate a more accurate and efficient processing of accounts payable for that business.

In the example embodiment, the APCS collects, tracks, displays, and disseminates near-real time accounts payable (AP) information. AP information includes information relating to accounts payable for a specific business. Accounts payable, also known as “trade payables,” are liabilities that represent obligations arising from the normal business activity of buying goods or services “on invoice” as distinguished from, for example, cash-on-delivery transactions. Accounts receivable, also known as “trade receivables,” are claims to cash resulting from such sale of goods or services “on invoice.” In connection with such “on-invoice” transactions, accounts receivables are in a sense the opposite of accounts payable. The former are reflected as assets on a supplier's balance sheet, the latter as liabilities on a buyer's.

The APCS enables an approved business to input AP information through a single computer workstation or a plurality of computer workstations that may be located at a single location or various locations. In addition, the APCS permits various approved users within the business to share AP information. The APCS also enables approved users to input invoices, process invoices, match invoices with purchase orders, approve invoices for payment, pay invoices, and confirm the payment of invoices. In addition, the APCS enables a user to manage appropriate write-offs and reporting capabilities. Furthermore, the APCS enables a user to accelerate payment of selected invoices so as to receive a discount for expedited payment of invoices, and manage the payment accelerator notification for future ready to pay transactions and payment notification when payments have been made.

AP information relating to a specific business is received by the APCS which stores the AP information in a database, updates the database with AP information received, tracks the AP information received, provides AP information in response to an inquiry, allows selected outside users to review and comment on AP information, and provides a report to at least one managerial user within the business summarizing the review of AP information for the business.

In the APCS, AP information is stored in the database. The network based APCS provides convenient access to AP information. A user must be authorized to gain access into the APCS. In the example embodiment, once the APCS home page is accessed, the user will be able to choose from a list of businesses for which the user is responsible or has been granted access by other users. Once the user selects the business to be reviewed, the user can review AP information relating to the business. In an example embodiment, only an authorized user can access the AP information.

In one embodiment, the system is a computer program embodied on a computer readable medium implemented utilizing Java® and Structured Query Language (SQL) with a client user interface front-end for administration and a web interface for standard user input and reports. (Java is a registered trademark of Sun Microsystems, Inc., Palo Alto, Calif.). In an example embodiment, the system is web enabled and is run on a business-entity's intranet. In yet another embodiment, the system is fully accessed by individuals having an authorized access outside the firewall of the business-entity through the Internet. In a further example embodiment, the system is being run in a Windows® NT environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

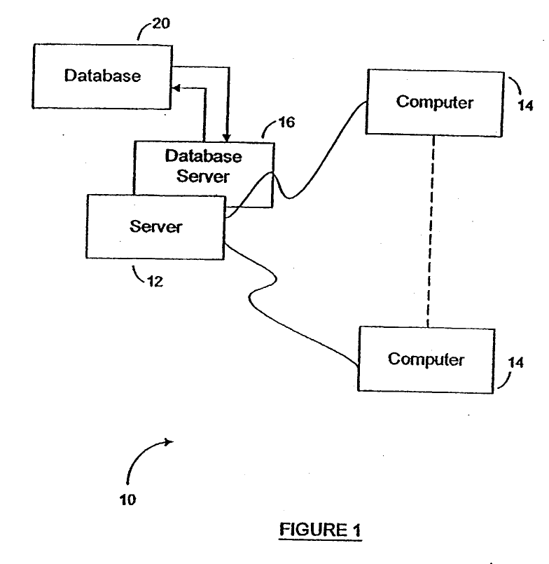

FIG. 1 is a simplified block diagram of an Accounts Payable Coordination System (APCS) 10 including a server system 12, and a plurality of client sub-systems, also referred to as client systems 14, connected to server system 12. In one embodiment, client systems 14 are computers including a web browser, such that server system 12 is accessible to client systems 14 via the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone, personal digital assistant (PDA), or other web-based connectable equipment. A database server 16 is connected to a database 20 containing information on a variety of matters, as described below in greater detail. In one embodiment, centralized database 20 is stored on server system 12 and can be accessed by potential users at one of client systems 14 by logging onto server system 12 through one of client systems 14. In an alternative embodiment database 20 is stored remotely from server system 12 and may be non-centralized.

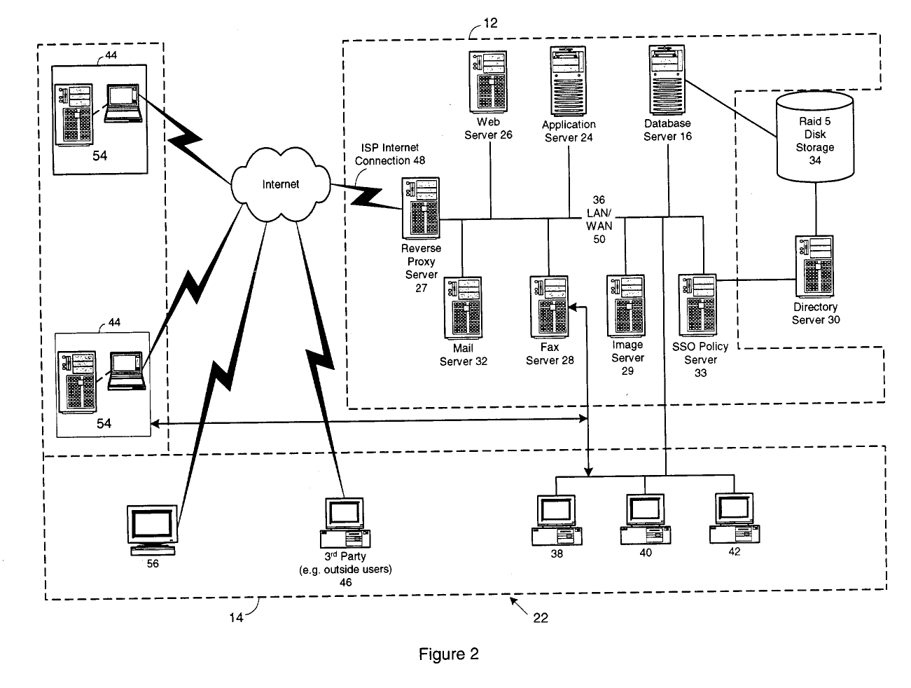

FIG. 2 is an expanded version block diagram of an example embodiment of a server architecture of a APCS 22. Components in system 22, identical to components of system 10 (shown in FIG. 1), are identified in FIG. 2 using the same reference numerals as used in FIG. 1. System 22 includes server system 12 and client systems 14. Server system 12 further includes database server 16, an application server 24, a web server 26, a Reverse Proxy server 27, a fax server 28, an image server 29, a directory server 30, a mail server 32, and an SSO Policy server 33. A disk storage unit 34 is coupled to database server 16 and directory server 30. Servers 16, 24, 26, 27, 28, 29, 30, 32 and 33 are coupled in a local area network (LAN) 36. Directory server 30 is coupled to SSO Policy server 33. In addition, a system administrator's workstation 38, a user workstation 40, and a supervisor's workstation 42 are coupled to LAN 36. Alternatively, workstations 38, 40, and 42 are coupled to LAN 36 via an Internet link or are connected through an Intranet.

Each workstation, 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36. In an example embodiment, client system 14 includes workstation 40 which can be used by an internal user or a designated outside user to review AP information relating to the analyzed business.

Server system 12 is configured to be communicatively coupled to various individuals, including employees 44 and to third parties, e.g., designated outside users, 46 via an ISP Internet connection 48. The communication in the example embodiment is illustrated as being performed via the Internet, however, any other wide area network (WAN) type communication can be utilized in other embodiments, i.e., the systems and processes are not limited to being practiced via the Internet. In addition, and rather than WAN 50, local area network 36 could be used in place of WAN 50.

In the example embodiment, any authorized individual having a workstation 54 can access APCS 22. At least one of the client systems includes a manager workstation 56 located at a remote location. Workstations 54 and 56 are personal computers having a web browser. Also, workstations 54 and 56 are configured to communicate with server system 12. Furthermore, fax server 28 communicates with remotely located client systems, including a client system 56 via a telephone link. Fax server 28 is configured to communicate with other client systems 38, 40, and 42 as well.

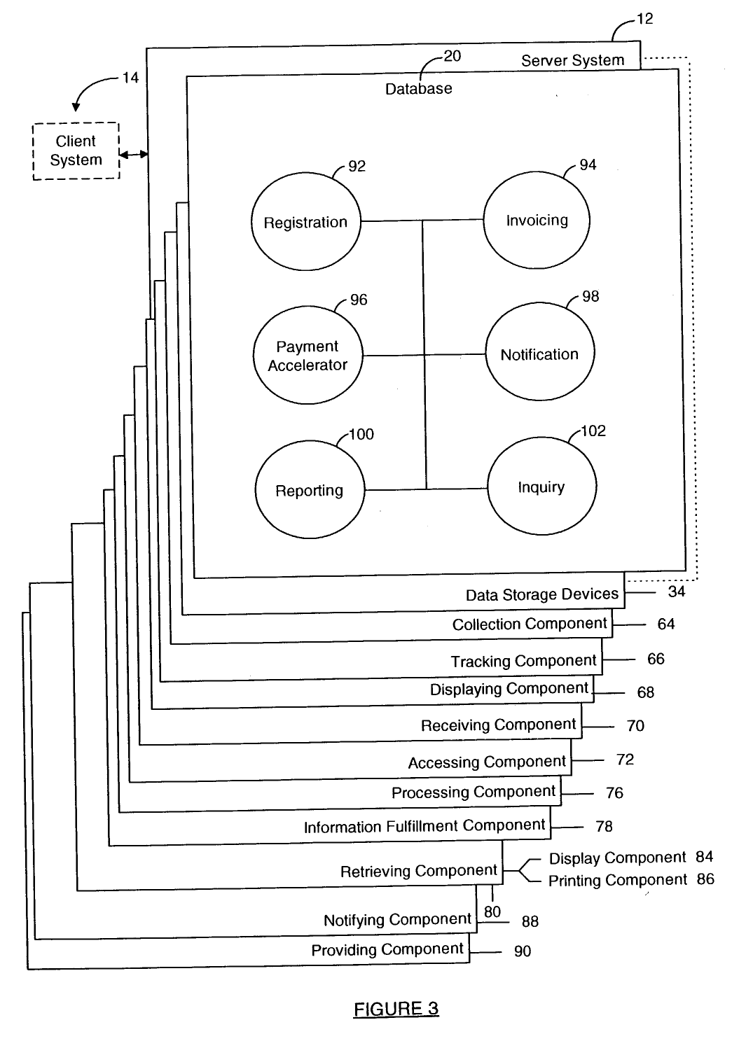

FIG. 3 shows a configuration of database 20 within database server 16 of server system 12 shown in FIG. 1. Database 20 is coupled to several separate computer software components within server system 12, which perform specific tasks. In the example embodiment, server system 12 includes a collection component 64 for collecting data from users in database 20, a tracking component 66 for tracking data, and a displaying component 68 to display information. Tracking component 66 tracks and cross-references data, including modifying existing data.

Server system 12 also includes a receiving component 70 to receive a specific query from client system 14, and an accessing component 72 to access database 20 within data storage device 34. Receiving component 70 is programmed to receive a query from one of a plurality of users. Server system 12 further includes a processing component 76 for searching and processing received queries against database 20 containing a variety of information collected by collection component 64. An information fulfillment component 78 located in server system 12 enables the requested information to be downloaded to the plurality of users in response to the requests received by receiving component 70. Information fulfillment component 78 downloads the information after the information is retrieved from database 20 by a retrieving component 80. Retrieving component 80 retrieves, downloads and sends information to client system 14 based on a query received from client system 14.

Retrieving component 80 also includes a display component 84 that is configured to download information to be displayed on a client system's graphical user interface, and a printing component 86 that is configured to print information. Retrieving component 80 generates reports requested by the user through client system 14 in a pre-determined format. System 10 is flexible to provide other alternative types of reports and is not constrained to the options set forth above.

Server system 12 also includes a notifying component 88 and a providing component 90. Notifying component 88 electronically transmits a message to client system 14 based on information inputted into server system 12, notifying a user of the status of the review of AP information by a user. Providing component 90 electronically provides a report to manager workstation 56 (shown in FIG. 2) summarizing the review of the AP information by a user, including findings and recommendations relating to whether an invoice should be paid.

In one embodiment, collection component 64, tracking component 66, displaying component 68, receiving component 70, processing component 76, information fulfillment component 78, retrieving component 80, display component 84, printing component 86, notifying component 88, and providing component 90 are computer programs embodied on computer readable medium.

Database 20 is divided into a Registration Section 92, an Invoicing Section 94, a Payment Accelerator Section 96, a Notification Section 98, a Reporting Section 100, and an Inquiry Section 102. Registration Section 92 includes information relating to users having access to APCS 10. Invoicing Section 94 includes information that is utilized for submitting and processing invoices within APCS 10. Payment Accelerator Section 96 includes information that enables a user to expedite ready to pay invoices that satisfy a payment accelerator criteria while allowing the business to take a discount for expedited payment of the invoices. Notification Section 98 includes information that enables a user to register a supplier or other users to receive payment notification based on a selected frequency, or notification whenever invoices satisfy the payment accelerator criteria. Reporting Section 100 includes information about various reporting functionality of APCS 10. Inquiry Section 102 includes information about inquiring invoices, payments, suppliers, purchase orders, and receivers.

System 10 accumulates a variety of confidential data and has different access levels to control and monitor the security of and access to system 10. Authorization for access is assigned by system administrators on a need to know basis. In one embodiment, access is provided based on job functions. In yet another embodiment, system 10 provides access based on business-entity The administration/editing capabilities within system 10 are also restricted to ensure that only authorized individuals have access to modify or edit the data existing in the system. System 10 manages and controls access to system data and information.

The architectures of system 10 as well as various components of system 10 are exemplary only. Other architectures are possible and can be utilized in connection with practicing the processes described below.

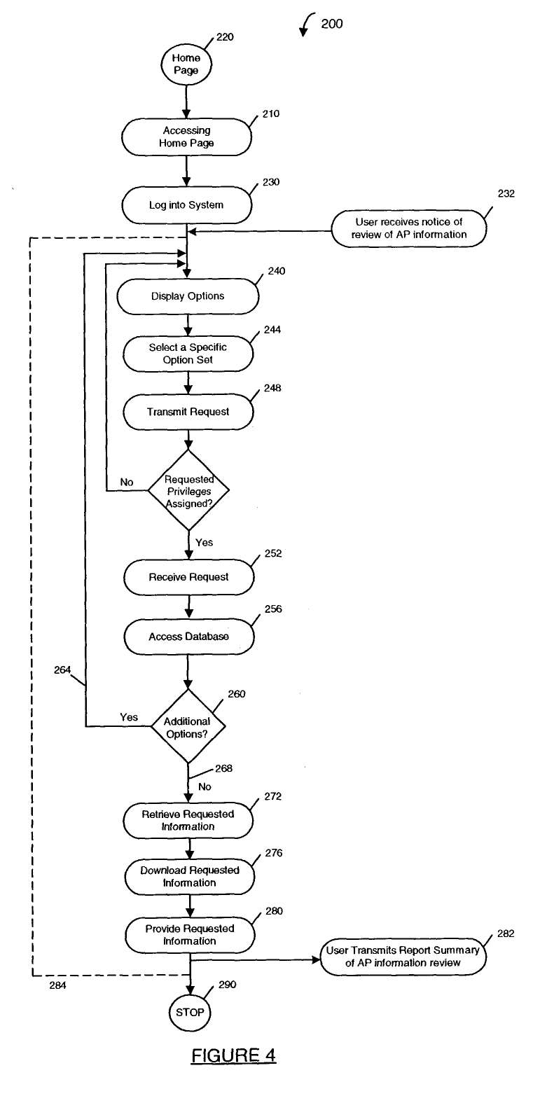

FIG. 4 is a flowchart 200 illustrating example processes utilized by system 10. The technical effect of APCS 10 is achieved by a user first accessing 210 a user interface, such as a home page 220, of the web site through client system 14 (shown in FIG. 1). In one embodiment, client system 14, as well as server system 12, are protected from access by unauthorized individuals. The user logs-in 230 to system 10 using a password (not shown) and an employee user login for security. The technical effect is further achieved through client system 14, which is configured to receive 232 an electronic notice indicating that a review of AP information 106 (shown in FIG. 3) has occurred, and whether any comments or findings were made relating to the review.

Client system 14 also displays 240 options available to the user through links, check boxes, or pull-down lists. Once the user selects 244 an option (in one embodiment, relating to a facility within the business entity) from the available links, the request is transmitted 248 to server system 12. Transmitting 248 the request is accomplished, in one embodiment, either by click of a mouse or by a voice command. Once server system 12 (shown in FIG. 1) receives 252 the request, server system 12 accesses 256 database 20 (shown in FIG. 1). System 10 determines 260 if additional narrowing options are available. In one embodiment, additional narrowing options relate to at least one of the analyzed business and AP information 106, and include check boxes, hyperlinks, buttons, and pull-down lists. If additional narrowing options are available 264, system 10 displays 240 the options relating to the prior option selected by the user on client system 14. The user selects 244 the desired option and transmits the request 248. Server system 12 receives the request 252 and accesses 256 database 20. When system 10 determines that additional options 260 are not available 268, system 10 retrieves 272 requested information from database 20. The requested information is downloaded 276 and provided 280 to client system 14 from server 12. Client system 14 transmits a report 282 from a user to manager workstation 56 (shown in FIG. 2) summarizing the review of AP information 106 by a user, including whether an invoice should be paid. The user can continue to search 284 database 20 for other information or exit 290 from system 10.

Registration

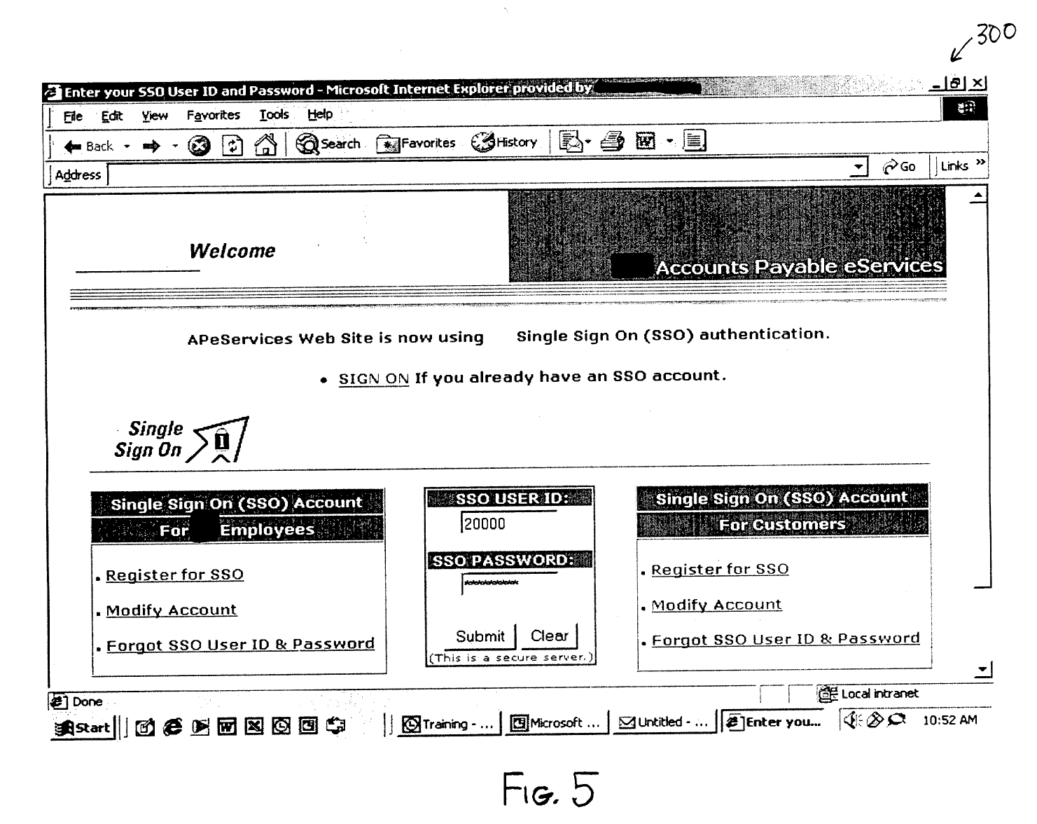

A user must register within APCS 10 before being granted permission to access certain modules within APCS 10. FIGS. 5 through 18 are example embodiments of user interfaces included within APCS 10 that enable a user to register to access APCS 10.

FIG. 5 is an example embodiment of a user interface 300 displaying a log in page within APCS 10 (shown in FIG. 1). User interface 300 includes a Single Sign On (SSO) User ID data field, a Single Sign On Password data field, a Submit button, and a Clear button. User interface 300 also includes a Register for SSO link, a Modify Account link, and a Forgot SSO User ID and Password link. Although buttons and data fields are shown in the example embodiment, pull-down lists, check boxes and other means for inputting this information could also be used. User interface 300 is the entry point for anyone trying to access APCS 10 and database 20 (shown in FIG. 1) via the web. After entering the Single Sign On User ID and the Single Sign On Password into the appropriate data fields, a user clicks on the Submit button in order to enter APCS 10.

By selecting the Modify Account link, a user can access that particular user's account and modify the information assigned to that account. By selecting Forgot SSO User ID and Password link, a screen is displayed prompting the user to input information. By inputting the requested information, APCS 10 provides the user with their assigned password.

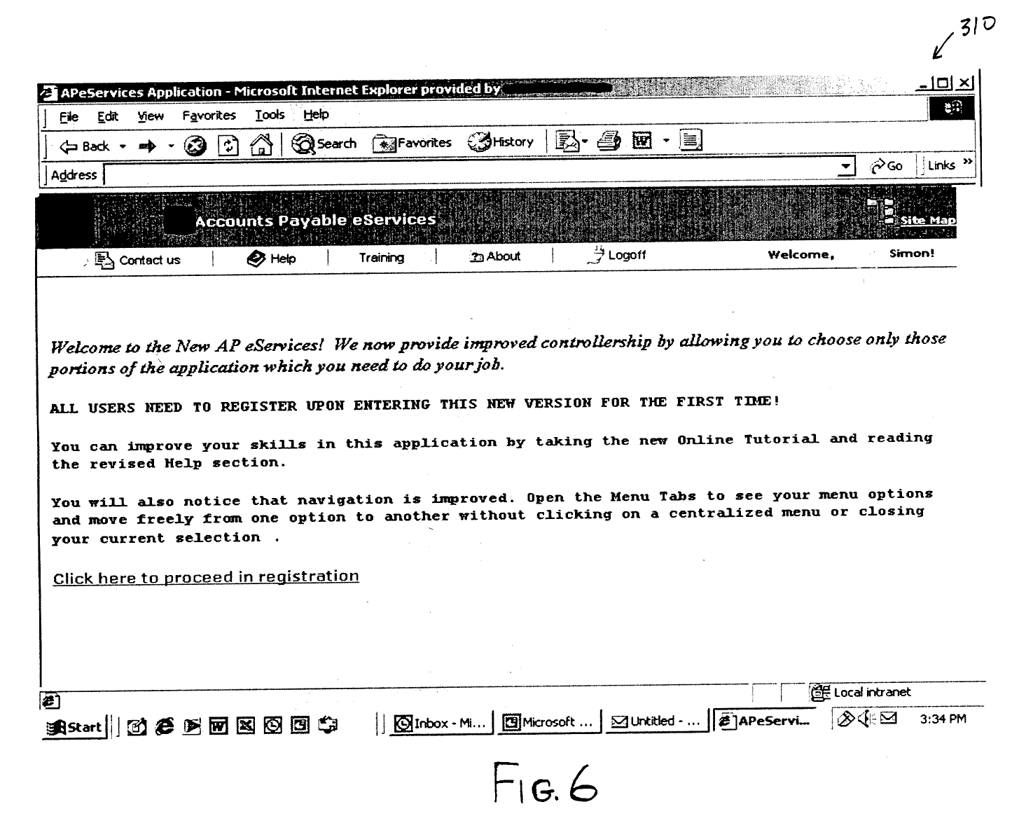

FIG. 6 is an example embodiment of a user interface 310 displaying a welcome page within APCS 10 (shown in FIG. 1). User interface 310 is displayed after a user has logged onto APCS 10. In the example embodiment, user interface 310 includes a “Click here to proceed in registration” link, which enables a user to register for approval by a designated approver (an Approver) before being granted permission to access APCS 10. By selecting the “Click here to proceed and registration” link, a screen is displayed prompting the user to input information. After inputting the requested information, APCS 10 transmits the user's information to an Approver, who in turn reviews the user information and either grants or denies the user's request for access to APCS 10. The Approver may also have to authority to grant or deny a user certain privileges, or certain accesses, within APCS 10.

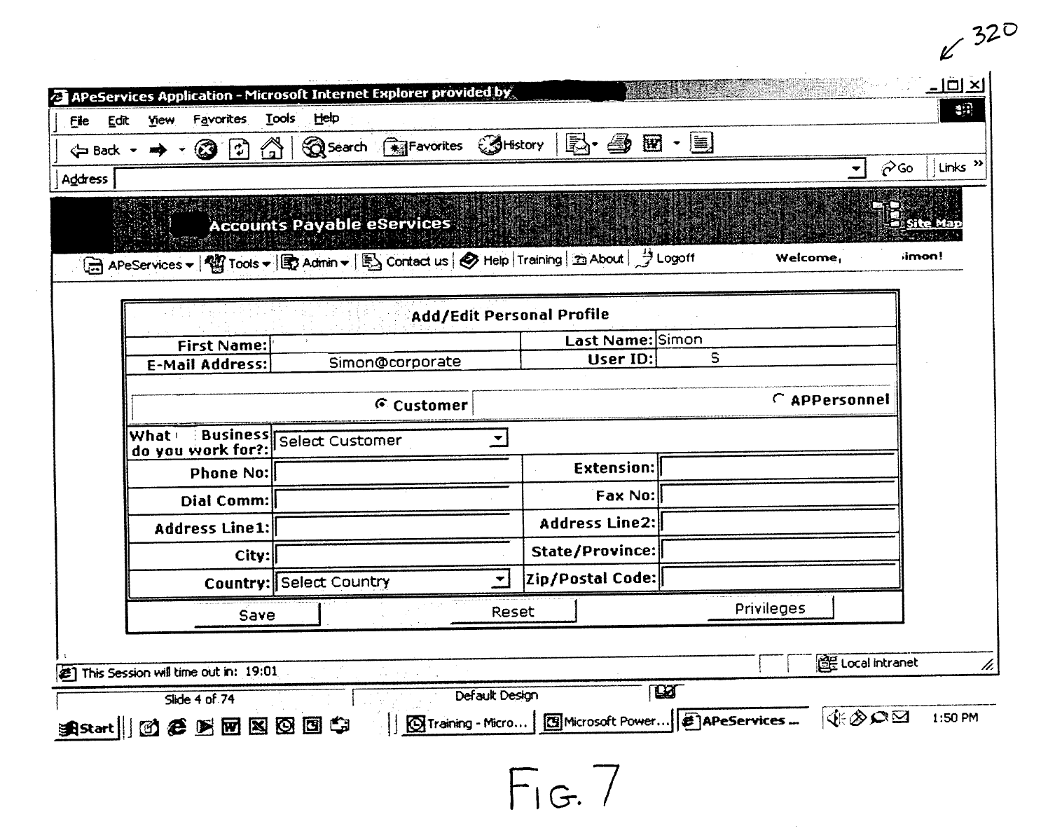

FIG. 7 is an example embodiment of a user interface 320 displaying an add/edit personal profile page within APCS 10 (shown in FIG. 1), which is displayed after a user has clicked on the “Click here to proceed in registration” link (shown in FIG. 6). In the example embodiment, user interface 320 displays a First Name data field, a Last Name data field, an E-mail Address data field, and a User ID data field. In the example embodiment, the data included within the First Name data field, the Last Name data field, the E-mail Address data field, and the User ID data field is automatically populated by APCS 10 based on the user signing on to APCS 10.

In the example embodiment, user interface 320 also displays a Customer radio button, which is clicked on by the user if the user works for a specific business within the company utilizing APCS 10. User interface 320 also displays a “What Business do you work for?” data field. If the user is a customer, the user must enter the appropriate information into the “What Business do you work for?” data field. In the example embodiment, user interface 320 also includes a plurality of data fields that relate to the user's contact information. The contact information data fields enable a user to add and/or edit the user's personal profile within APCS 10 by entering the requested information. After inputting the requested information, the user clicks on a Save button to store the personal profile information into APCS 10. In the example embodiment, user interface 320 also includes a Reset button and a Privileges button.

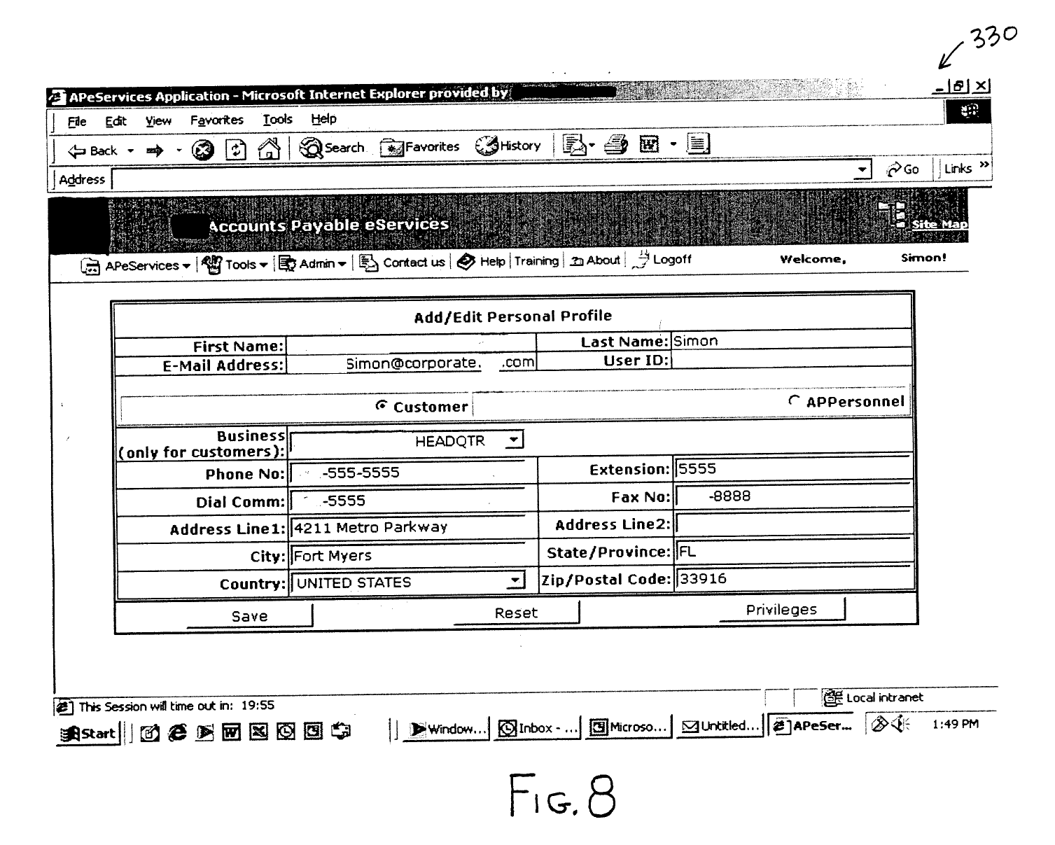

FIG. 8 is an example embodiment of an user interface 330 displaying an add/edit personal profile page within APCS 10 (shown in FIG. 1). In the example embodiment, user interface 330 displays the add/edit personal profile page with the user's information entered into the profile page.

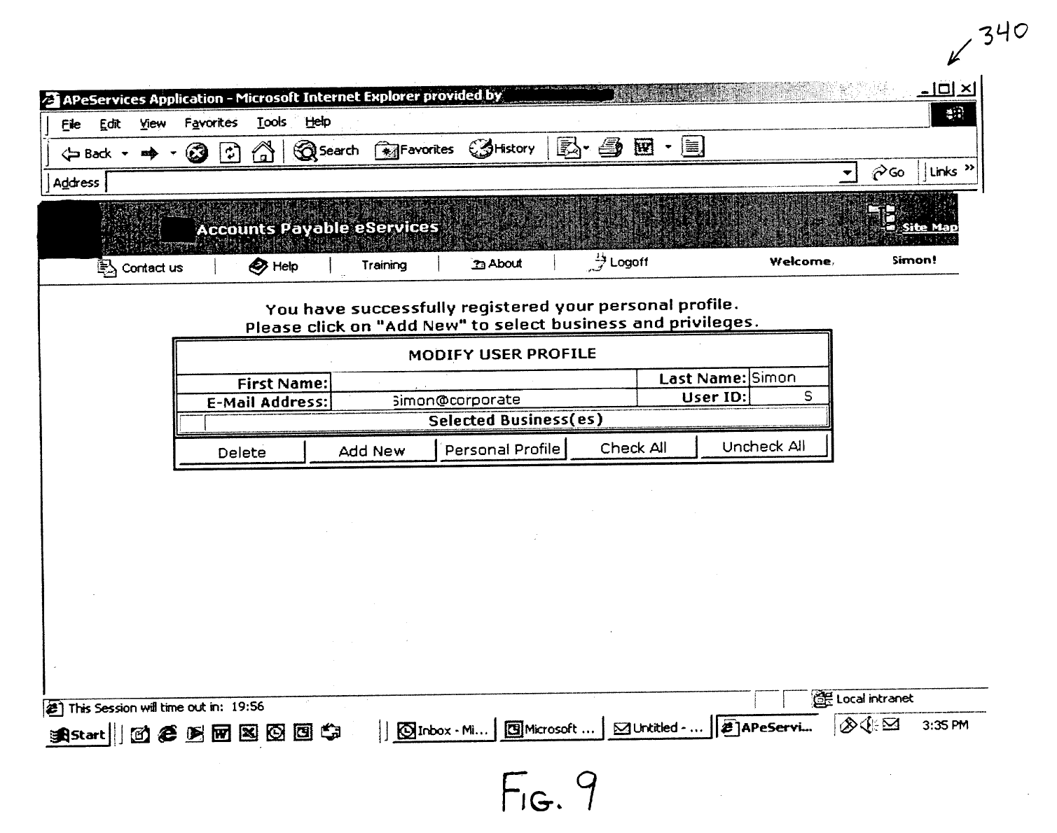

FIG. 9 is an example embodiment of a user interface 340 displaying a modify user profile page within APCS 10 (shown in FIG. 1). In the example embodiment, after a user has successfully registered their personal profile within APCS 10, a modify user profile page may be displayed by the user. User interface 340 displays a First Name data field, a Last Name data field, an E-Mail Address data field, and a User ID data field that corresponds with the user's sign-on to APCS 10. In the example embodiment, user interface 340 includes a Delete button, an Add New button, a Personal Profile button, a Check All button, and an Uncheck All button. The Add New button displayed on user interface 340 enables a user to select a business or businesses that the user would like access to with APCS 10. The user requests access to these businesses by selecting the Add New button and then by entering the businesses the user desires access to. An Approver will then review, and either grant or deny such a request by a user.

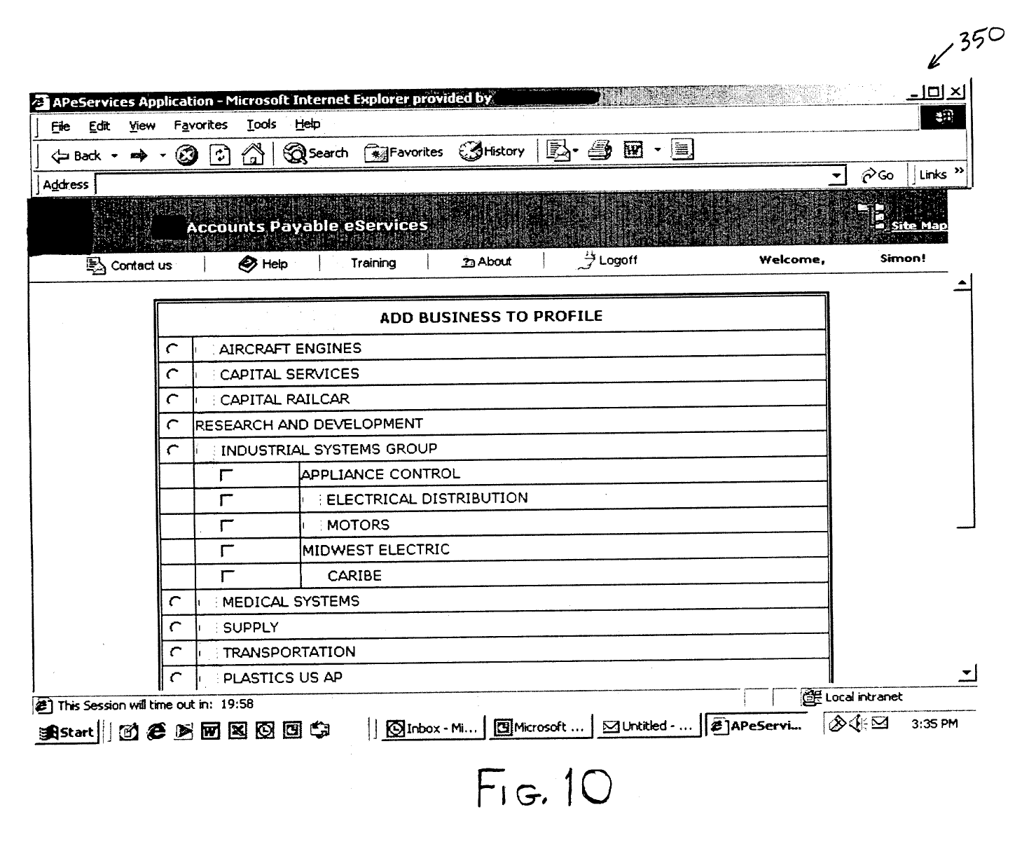

FIG. 10 is an example embodiment of a user interface 350 displaying an add business to profile page within APCS 10 (shown in FIG. 1), which is displayed after a user clicks on the Add New button included on user interface 340 (shown in FIG. 9). User interface 350 enables a user to add a business or businesses, or a division within a business to a user profile. More specifically, by selecting a business or businesses to be added to a user profile through user interface 350, the user is requesting to be approved to access information included within APCS 10 for the selected business, businesses, or division. In the example embodiment, user interface 350 includes at least one of an aircraft engines business, a capital services business, a capital railcar business, a research and development business, an industrial systems group business, a medical systems business, a supply business, a transportation business, and a plastics US AP business. In the example embodiment, each business included on user interface 350 has a corresponding radio button. In order to select a business, the user selects the corresponding radio button for that business. In the example embodiment, the industrial systems group business included on user interface 350 also includes an appliance control division, an electrical distribution division, a motors division, a midwest electric division, and a caribe division. Each division includes a corresponding check box. After a user has selected the businesses and/or divisions that it would like access to, the user clicks on an Add button (not shown) to submit the information to APCS 10 for approval by an Approver.

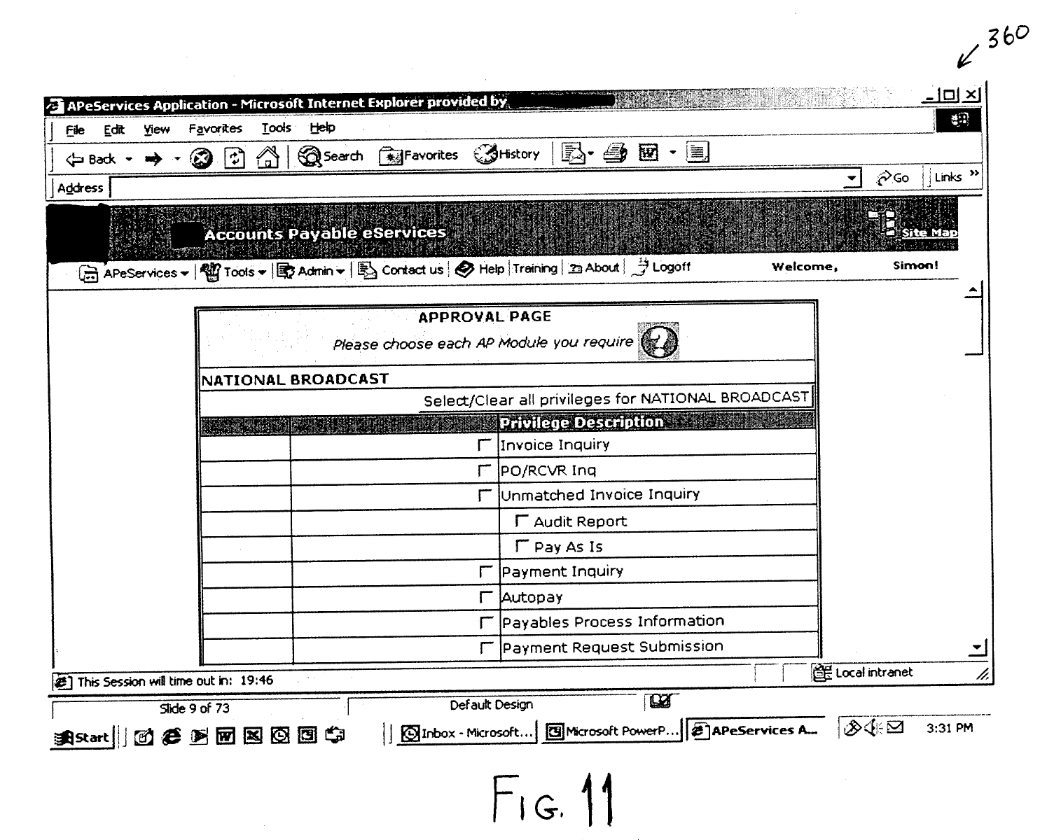

FIG. 11 is an example embodiment of a user interface 360 displaying an approval page within APCS 10 (shown in FIG. 1). User interface 360 enables a user to select modules, also known as privileges, that the user would like access to within APCS 10. In the example embodiment, user interface 360 displays the following privileges: an Invoice Inquiry, a PO/RCVR Inq., an Unmatched Invoice Inquiry, a Payment Inquiry, an Autopay, a Payable Process Information, and a Payment Request Submission.

In the example embodiment, the Invoice Inquiry privilege enables a user to access Accounts Payable (AP) invoice data at a summary and detail level within APCS 10. The Invoice Inquiry privilege also enables a user to view images of invoices included within APCS 10. The Purchase Order and Receiver Inquiry (PO/RCVR Inq.) privilege enables a user to access Purchase Orders ordered, received and apply invoice data at summary and detail level within APCS 10. The Unmatched Invoice Inquiry privilege enables a user to access data on all invoices that have a matching discrepancy within APCS 10. The Unmatched Inquiry privilege also includes a Fix-It utility which allows the user to make changes to an invoice, make notations of a change to a Purchase Order (PO), make deletions, and Pay As Is for specified users. The Payables Process Information privilege enables a user to access AP critical customer and performance measurements. The functionality included within the Payables Process Information privilege includes creating graphs, summary tables, and detailed reports from invoice data. The Payment Request Submission privilege includes a work flow enabled check request application to be used to facilitate payment to a vendor when no invoice has been or will be submitted. The Payment Request Submission privilege is used for Non-Purchase Order related items only.

In the example embodiment, user interface 360 prompts the user to select the modules, also known as privileges, that the user would like access to. After selecting the module or modules that the user would like access to, the user then selects from a data pull-down field (not shown), an Approver to review the inputted information for the particular user. After inputting the requested information, the user then selects a Next button (not shown) to submit the information into APCS 10.

In the example embodiment, the Unmatched Invoice Inquiry and Fix-It functionalities are intended to be used by users that are also buyers.

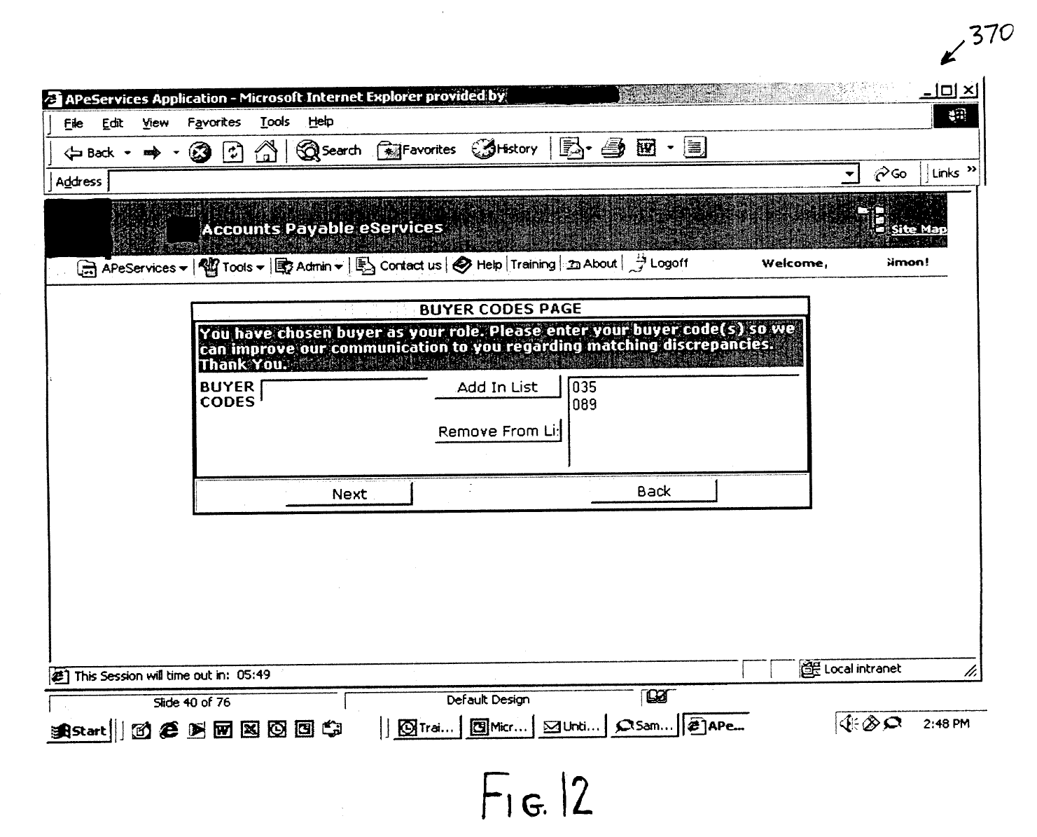

FIG. 12 is an example embodiment of a user interface 370 displaying a buyer codes page within APCS 10 (shown in FIG. 1), which is displayed when a user has selected “buyer” as their role. In the example embodiment, user interface 370 displays a Buyer Codes data field, a data box, an Add-In List button, and a Remove From List button. User interface 370 enables a user to enter buyer codes into the Buyer Codes data field and add them to the data box or remove them from the data box using the Add-In List button or the Remove From List button, respectively. The buyer codes displayed in the data box are used by APCS 10 to facilitate unmatched invoice notification for non-standard purchasing systems.

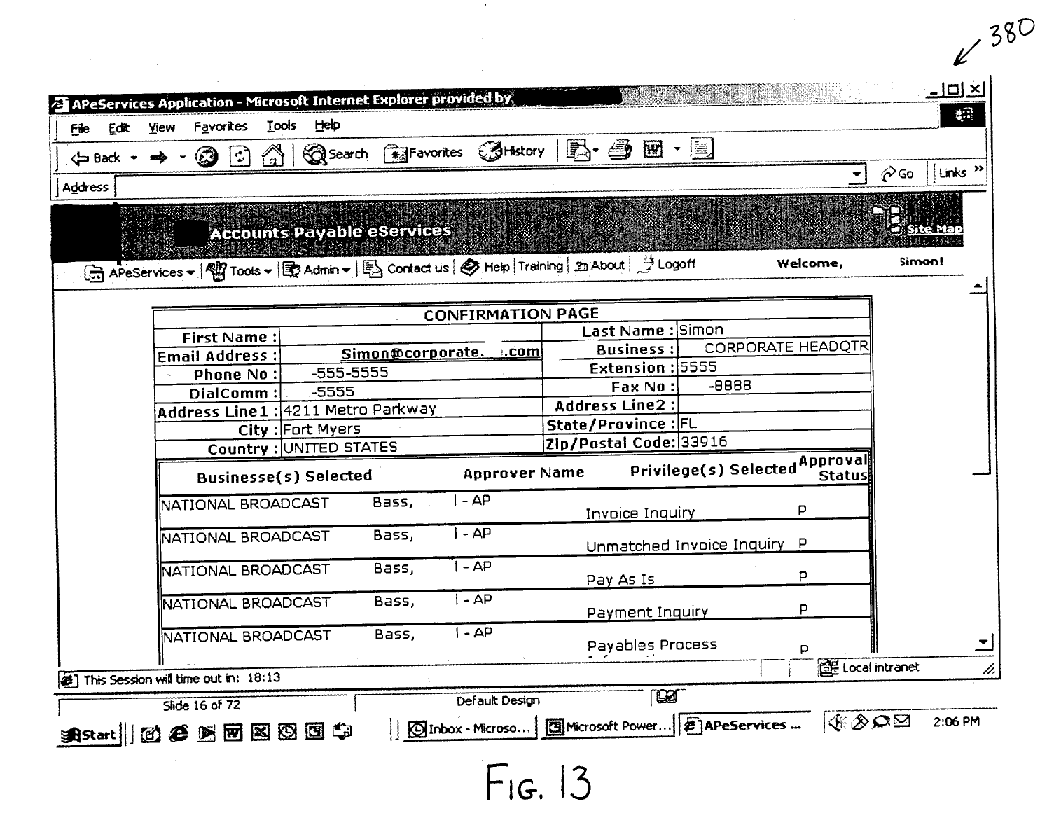

FIG. 13 is an example embodiment of a user interface 380 displaying a confirmation page within APCS 10 (shown in FIG. 1). User interface 380 enables a user to review profile information entered into APCS 10 and confirm that the profile information entered is correct. In the example embodiment, user interface 380 includes a First Name data field, a Last Name data field, an E-Mail Address data field, a Business data field, and contact information for the user. User interface 380 also displays the businesses selected by the user for access, the Approver name for each of the selected businesses, the privileges selected for each selected business, and the approval status for each privilege. In the example embodiment, user interface 380 displays the approval status as “P”, which means that the approval status is still pending. After a user has reviewed and confirmed the accuracy of the profile information, APCS 10 generates a message screen (not shown) that advises the user that the profile information has been successfully modified. The message screen also advises the user to wait to receive email notification through APCS 10 that will advise the user as to whether the user has been approved for the modules requested.

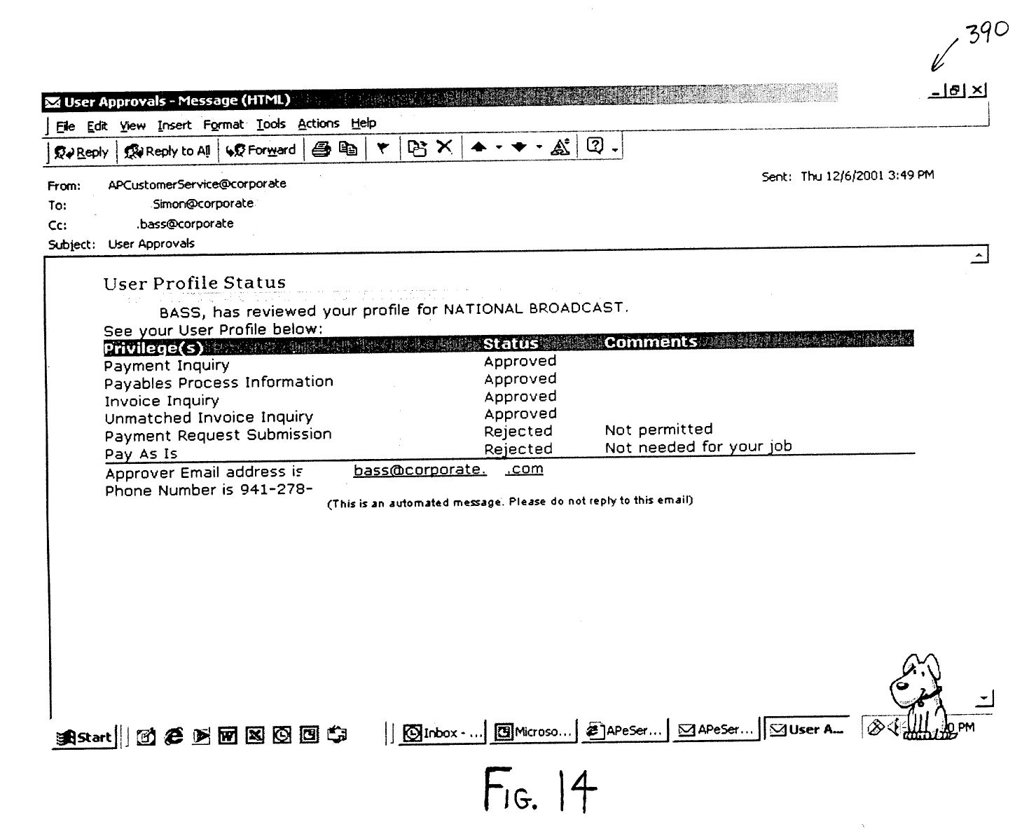

FIG. 14 is an example embodiment of a user interface 390 displaying an approval email within APCS 10 (shown in FIG. 1), which is displayed after a user has been approved for requested access within APCS 10. In the example embodiment, user interface 390 illustrates that an Approver has reviewed the user profile information for a selected business, and has approved certain privileges included within APCS 10 that were requested by the user and has denied certain privileges included within APCS 10 that were requested by the user. If a user has questions as to why the user was not approved for certain privileges, user interface 390 prompts the user to contact the Approver that reviewed the user's information.

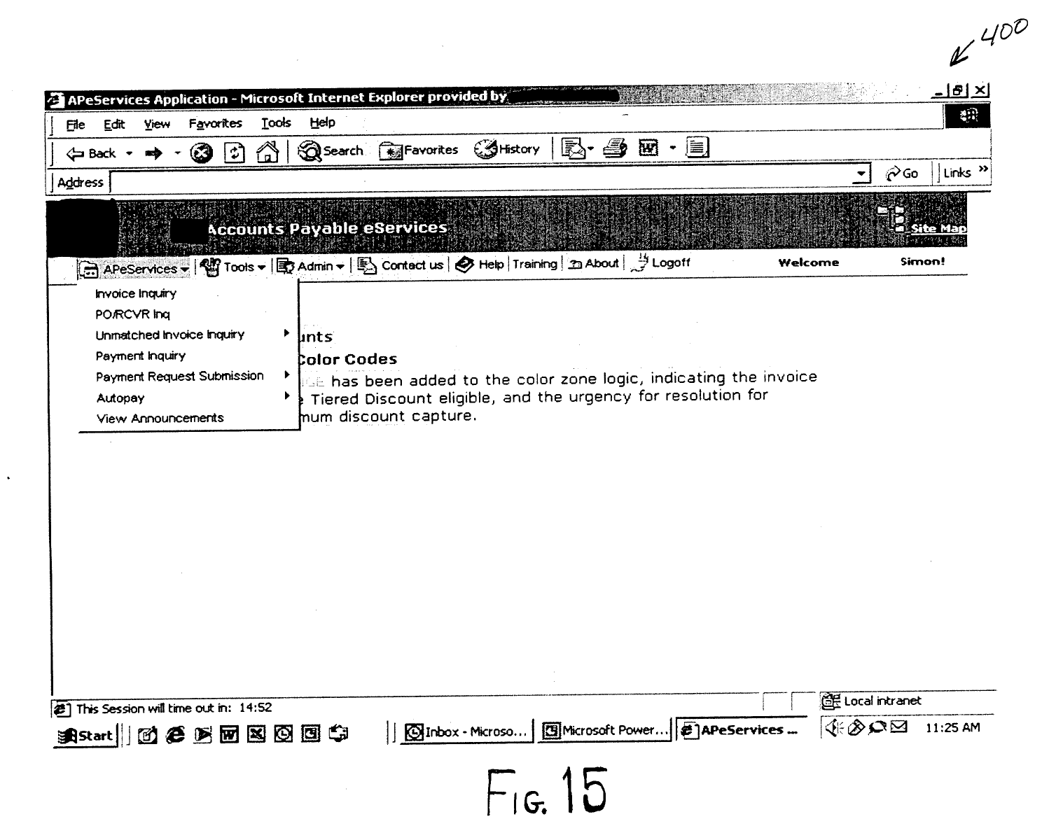

FIG. 15 is an example embodiment of a user interface 400 displaying a common navigational bar utilized by APCS 10 (shown in FIG. 1). In the example embodiment, the navigational bar is displayed near the top of user interface 400 and includes an APeServices pull-down list, a Tools pull-down list, an Admin pull-down list, a Contact Us button, a Help button, a Training button, an About button, and a Log-off button. In the example embodiment, the APeServices pull-down list includes those modules that the user has been approved for within APCS 10, excluding Payables Process Information. In the example embodiment, the modules included within the APeServices pull-down list include Invoice Inquiry, PO/RCVR Inq., Unmatched Invoice Inquiry, Payment Inquiry, Payment Request Submission, Auto-Pay, and View Announcements.

The Tools pull-down list includes a Payables Process Information function and a Self-Test File Feeds function. The Payable Process Information function also includes Paid On Time Measurements, Efinance, and rework measurements. The Self-Test File Feeds function includes Submit File and View Status.

The functions included within the Admin pull-down lists depend on the status of the user within APCS 10. If the status of a user is as a User, the functions include within the Admin pull-down list include a Change Profile function, which allows the user to change their personal profile or request a change to their privilege access. If, however, the status of the user is an Approver, the functions included within the Admin pull-down list would include the Change Profile function, and a Pending Approvals function. The Pending Approvals function allows an Approver to review all Pending Privileges requests, and grant or deny privileges. If, however, the status of the user is as an Administrator, the functions included within the Admin pull-down list would include the Change Profile function, and a Business Administrator function. The Business Administrator function contains all of the administrative options included within APCS 10. If a user is designated as both an Administrator and an Approver, the Admin pull-down list would include the Change Profile function, the Pending Approvals function, and the Business Administrator function.

In the example embodiment, the Change Profile function includes two options: My Personal Profile, and My Business/Privilege Profile. By selecting My Personal Profile, a user can edit their personal profile stored within APCS 10. By selecting My Business/Privilege Profile, a user can request a modification to the privileges assigned to the user for each business within APCS 10, and add or delete businesses that the user has access to within APCS 10.

The Pending Approval function included within the Admin pull-down list allows Approvers to review all pending requests, and grant or deny privileges.

The Business Administrator function included within the Admin pull-down list includes three options: Administer User Profile, Administer Approvers, and Administration Reports. The Administer User Profile function allows Administrators to grant or deny privileges for all users at their business. The Administer Approvers function allows Administrators to add or remove APeServices Approvers for their business. The Administration Report function allows Administrators to download listings of users, Approvers, and Approvers by privilege.

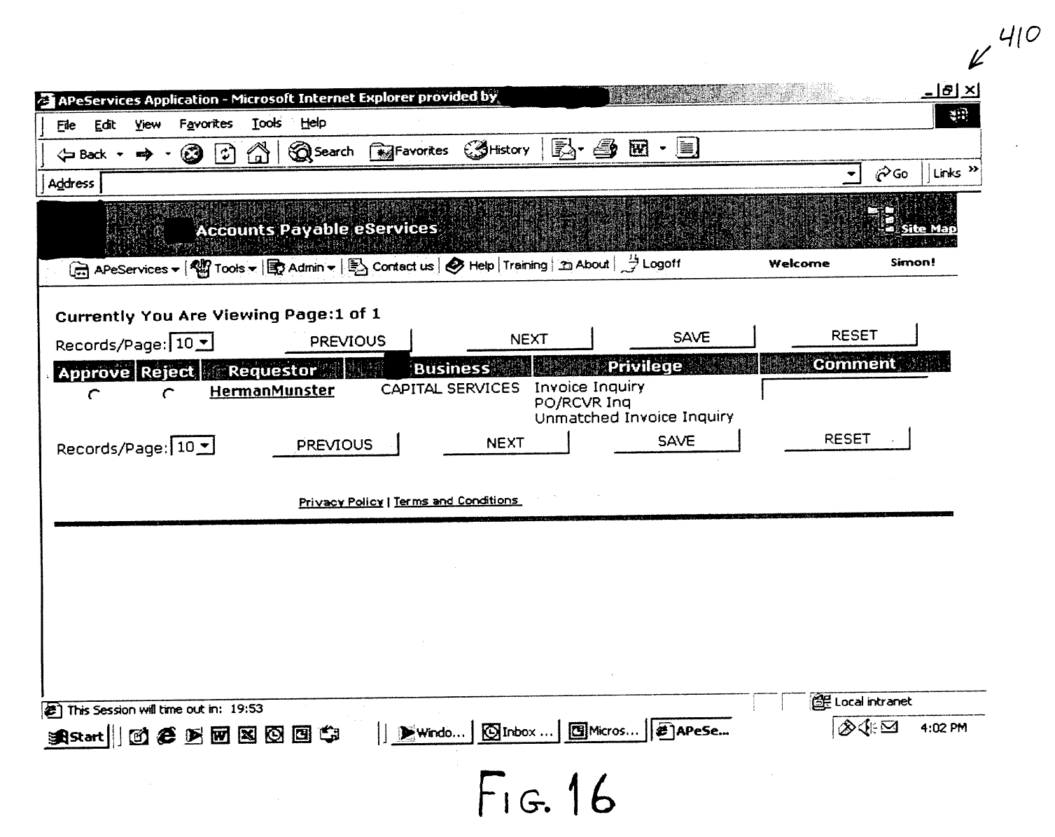

FIG. 16 is an example an embodiment of the user interface 410 displaying a pending approval page within APCS 10 (shown in FIG. 1), which is displayed after an Approver selects the Pending Approvals function under the Admin pull-down list (shown in FIG. 15). In the example embodiment, user interface 410 displays a page showing a user that has requested approval for new privileges within APCS 10. User interface 410 displays an Approve radio button, a Reject radio button, a Requester a Business, and each privilege the user has requested access to within APCS 10. Using user interface 410, an Approver may approve or reject all requested privileges for this particular user. User interface 410 also enables the Approver to comment or explain a rejection. The user will then receive approval or rejection notification with comments through an email.

In another embodiment, user interface 410 prompts an Approver to approve or reject each privilege on an individual basis that has been requested by a user within APCS 10. The Approver may then approve or reject each privilege requested by the user, and provide comments as to why each privilege has been approved or rejected. The user then receives such information through an email.

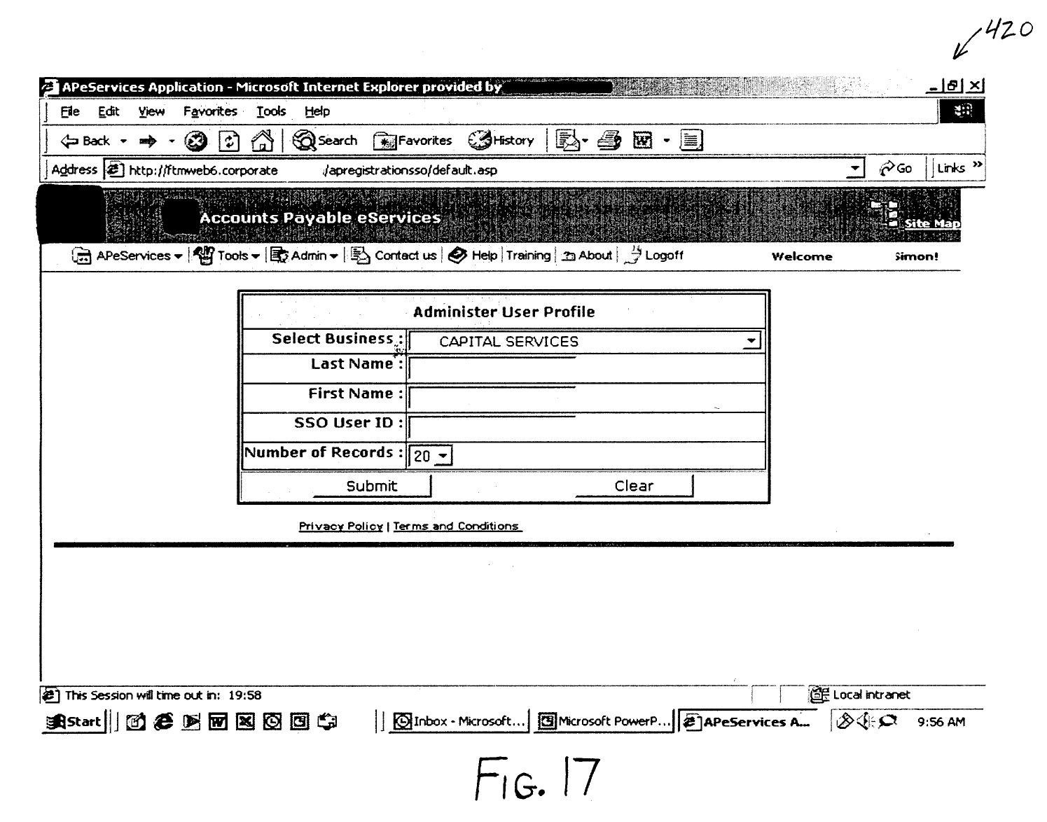

FIG. 17 is an example and embodiment of an user interface 420 displaying an administrator user profile page within APCS 10 (shown in FIG. 1), which is displayed after an Administrator selects the Administer User Profile function. In the example and embodiment, user interface 420 includes a Select Business pull-down list, a Last Name data field, a First Name data field, an SSO User ID data field, and a Number of Records pull-down list. User interface 420 enables an Administrator to modify privileges (i.e., adding or deleting) granted to a specific user included within a business assigned to the Administrator. Once the Administrator modifies the privileges granted to a user, the change is immediately made within APCS 10 such that the user will notice the change the next time the user logs onto APCS 10.

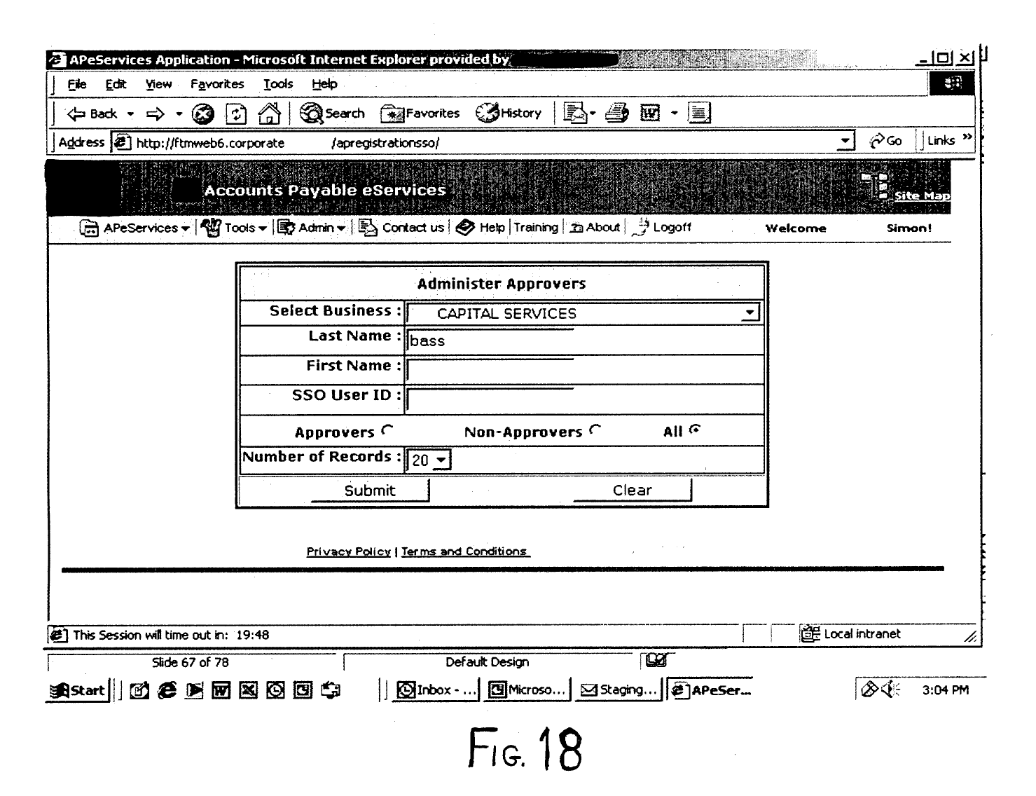

FIG. 18 is an example embodiment of an user interface 430 displaying an administer approvers page within APCS 10 (shown in FIG. 1), which is displayed after an Administrator selects the Administer Approvers function. In the example embodiment, user interface 430 includes a Select Business pull-down list, a Last Name data field, a First Name data field, an SSO User ID data field, an Approvers radio button, a Non-Approvers radio button, and an All radio button. User interface 430 enables an Administrator to modify an Approval Status for a specific user. User interface 430 prompts an Administrator to grant Approver permissions to a particular user within APCS 10. User interface 430 also prompts an Administrator to revoke Approver permissions from a particular user within APCS 10. Once the Administrator has approved or revoked Approver permissions for a user, the Administrator selects a Submit button and the information is submitted to APCS 10.

Invoicing

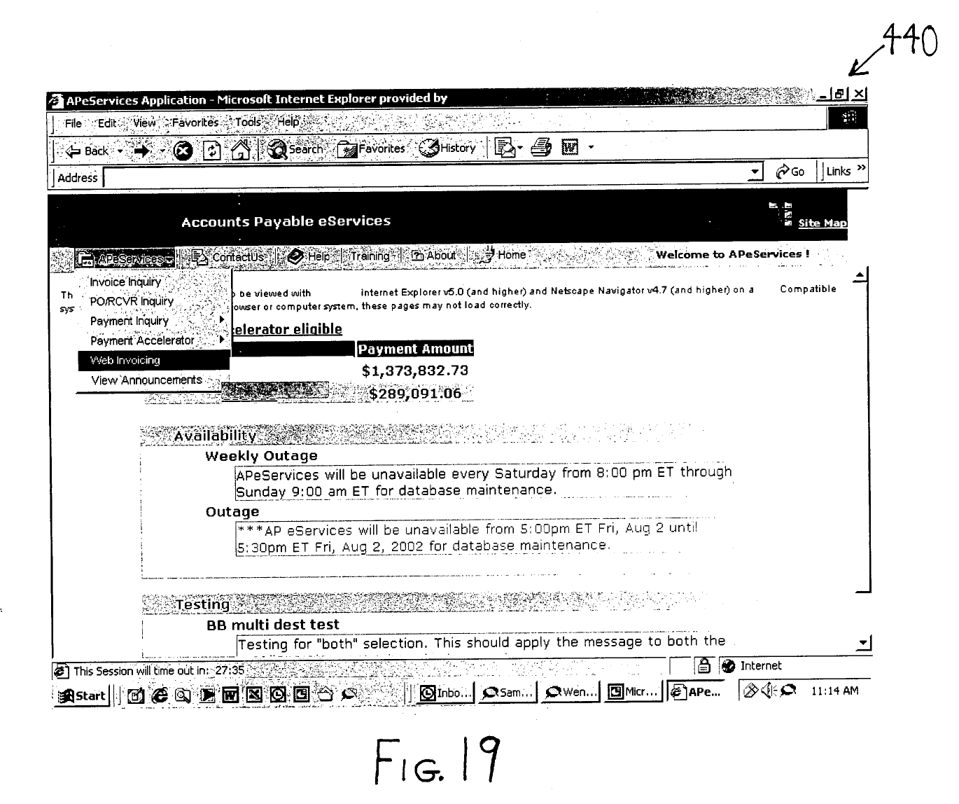

The APCS also enables authorized users to submit invoices for processing and payment. FIGS. 19 through 30 are example embodiments of user interfaces included within APCS 10 that enable a user to submit for processing and payment such invoices.

FIG. 19 is an example embodiment of a user interface 440 displaying a web invoicing page within APCS 10 (shown in FIG. 1), which is displayed when a user selects the APeServices pull-down list included on the common navigational bar. By selecting the Web Invoicing function included within the APeServices pull-down list, a user can submit, search, and process invoices within the APCS 10.

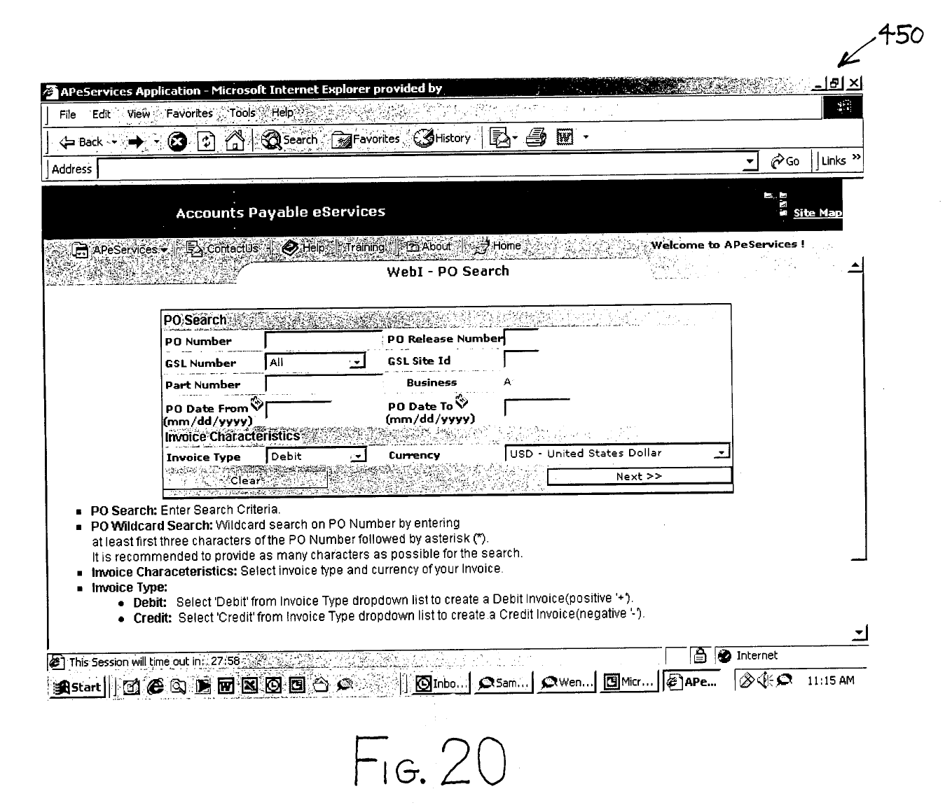

FIG. 20 is an example embodiment of a user interface 450 displaying a purchase order search page within APCS 10 (shown in FIG. 1), which enables a user to search for a Purchase Order (PO) within APCS 10. In the example embodiment, user interface 450 displays a PO Number data field, a GSL Number pull-down list, a Part Number data field, a PO Date From data field and a PO Date To data field, a PO Release Number data field, a GSL Site ID data field, an Invoice Type pull-down field, a Currency pull-down field, a Clear button, and a Next button. To conduct a PO search, a user enters a search criteria within user interface 450. A PO wildcard search can also be performed. A wildcard search on a PO Number is performed by entering the at least first three characters of the PO Number followed by an asterisk (*). User interface 450 also displays an Invoice Characteristics section that includes the Invoice Type and Currency of the invoice. The Invoice Type includes a debit invoice and a credit invoice.

In the example embodiment, if the user has not entered a PO Number to perform a PO search, the user must select a GSL Number from the GSL Number pull-down list. The user may also enter the GSL Site ID Number in the GSL Site ID data field to narrow the search by a specific location.

In the example embodiment, the Invoice Type pull-down list includes a debit invoice and a credit invoice. A debit invoice is an invoice or bill directed to the business utilizing APCS 10. A credit invoice is an invoice where money is being returned to the business utilizing APCS 10. In the example embodiment, the user must provide both invoice type and currency when performing a PO search within APCS 10. Once all search criteria information is entered into user interface 450, a user clicks on the Next button.

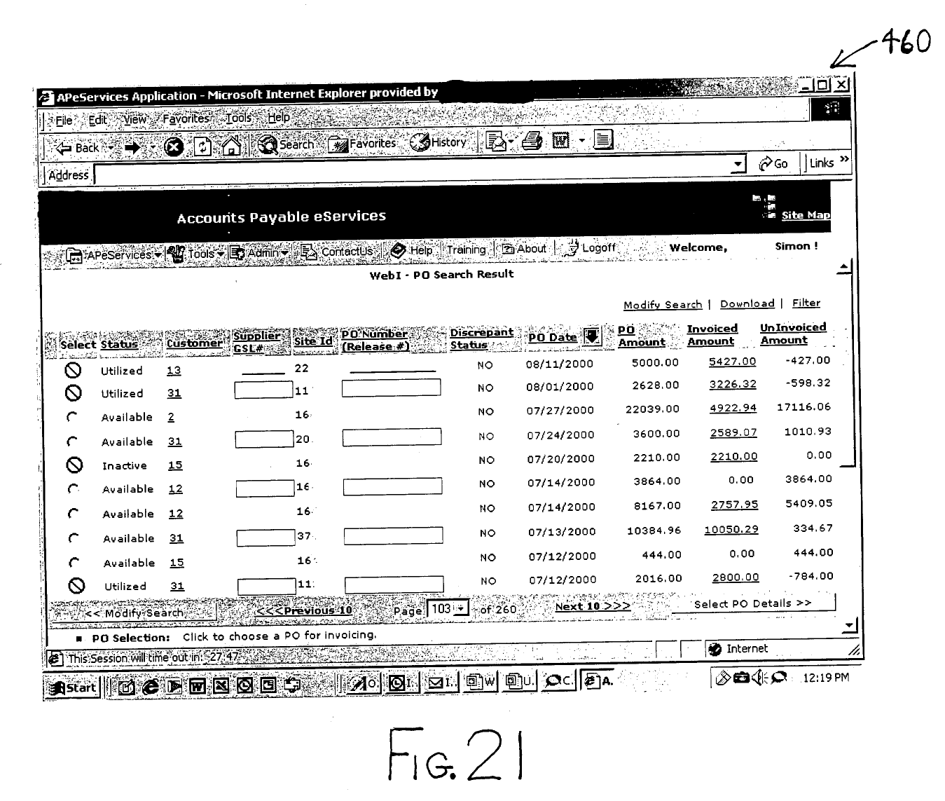

FIG. 21 is an example embodiment of a user interface 460 displaying a purchase order search result page within APCS 10 (shown in FIG. 1), which is displayed after a user conducts a purchase order search within APCS 10. In the example embodiment, user interface 460 includes a Select column, a Status column, a Customer column, a Supplier GSL # column, a Site ID column, a PO Number column, a Discrepant Status column, a PO Date column, a PO Amount column, an Invoiced Amount column, an UnInvoiced Amount column. User interface 460 also includes a Modify Search link, a Download link, and a Filter link. The POs displayed on user interface 460 are those that match the search criteria entered by the user through user interface 450 (shown in FIG. 20).

To modify the PO search conducted by the user, the user clicks on the Modify Search link displayed on user interface 460. The user can also download the search results by clicking on the Download link, or can filter (i.e., narrow) the PO criteria by clicking on the Filter link.

After a user clicks on the Filter link, a pop-up screen (not shown) is displayed which allows the user to filter the PO search results. The pop-up screen includes a GSL Number data field, a From PO Date data field, a To PO Date data field, a PO Amount From data field, a PO Amount To data field, and a Status pull-down list. The filter pop-up screen enables a user to further narrow the search conducted by the user for a particular purchase order.

The Select column displayed on user interface 460 enables a user to select a PO to invoice or apply a credit against. The Status column indicates whether a PO has been utilized, is available, is invoiceless, or is inactive. In the example embodiment, if the PO entered is displayed and has a status of Utilized, the PO has been invoiced to its full funded amount. In such a case, if invoices remain that need to be billed to that PO, the user must contact a buyer for assistance. In the example embodiment, a user will not be able to invoice against a Utilized PO. However, in the example embodiment, a user will be able to enter a credit against a Utilized PO. The Status column may also include a status of “Invoiceless”. If the PO entered is displayed and a PO line has a status of Invoiceless, a user cannot send an invoice to accounts payable for that line. Payment of merchandise for this type of PO line is created based on the receipt of the merchandise. The Status column may also include a status of “Inactive”. If the PO entered is displayed and has a status of Inactive, the PO has been deactivated by the assigned buyer. An Inactive PO is a PO that cannot be invoiced against or have a credit assigned to it.

In the example embodiment, user interface 460 also includes a Select PO Details button. User interface 460 enables a user to select a PO from a PO search result page and then click on the Select PO Details button to display further details regarding the selected PO.

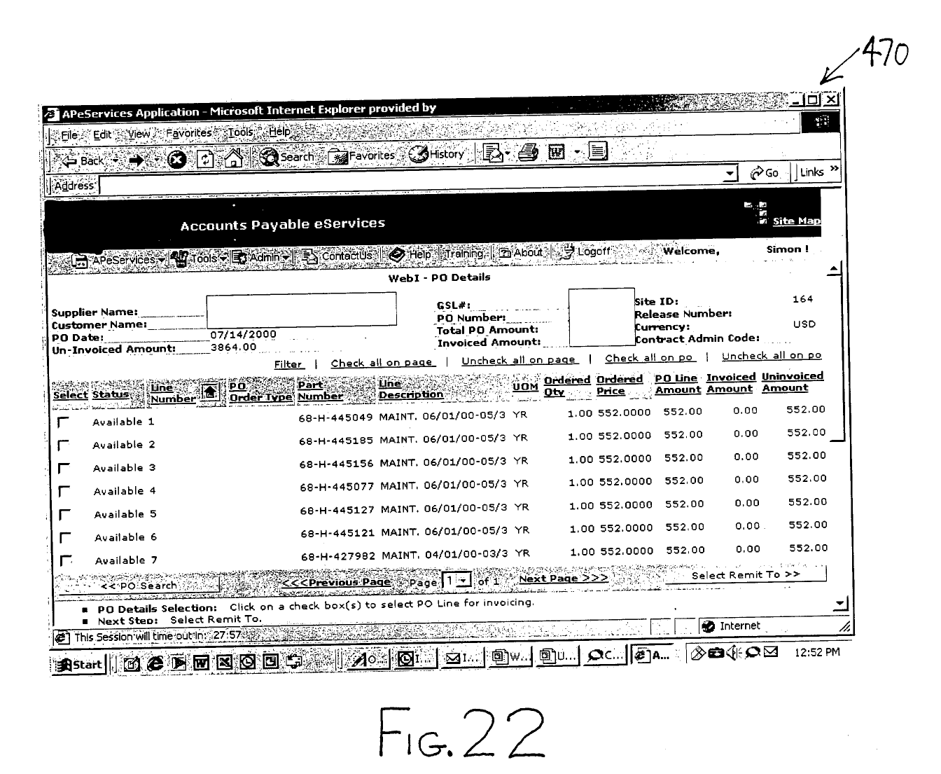

FIG. 22 is an example embodiment of a user interface 470 displaying a purchase order details page within APCS 10 (shown in FIG. 1), which is displayed after a user selects the Select PO Details button displayed user interface 460 (shown in FIG. 21). In the example embodiment, user interface 470 displays a Supplier Name data field, a Customer Name data field, a PO Date data field, and an UnInvoiced Amount data field. User interface 470 also displays a Select column, a Status column, a Line Number column, a PO Order Type column, a Part Number column, a Line Description column, a UOM column, an Ordered Quantity column, an Ordered Price column, a PO Line Amount column, an Invoiced Amount column, and an UnInvoiced Amount column. User interface 470 also displays a Filter link, a Check All on Page link, an Uncheck All on Page link, a Check All on PO link, and an Uncheck All on PO link.

The filter link displayed on user interface 470 enables a user to filter (i.e., narrow) the PO line criteria. After a user selects the Filter link, a pop-up screen (not shown) is displayed which prompts the user to input PO information to filter the search for a particular PO line. The pop-up screen enables the user to filter by at least one of a Part Number, a PO Line Number, a Status, a PO Order Type, and a PO Line Number To.

The Check All on Page link enables a user to select all PO lines displayed on user interface 470. The Uncheck All on Page link enables a user to unselect all PO lines on the screen. The Check All on PO link enables a user to select all lines on a PO available for invoicing. The Uncheck All on PO Link enables a user to unselect all lines on a PO.

In the example embodiment, user interface 470 also enables a user to select a PO line for invoicing or applying a credit. The user selects the specific PO line by clicking on the check box located in the Select column for the corresponding PO line. The user then clicks on a Select Remit To button displayed on user interface 470.

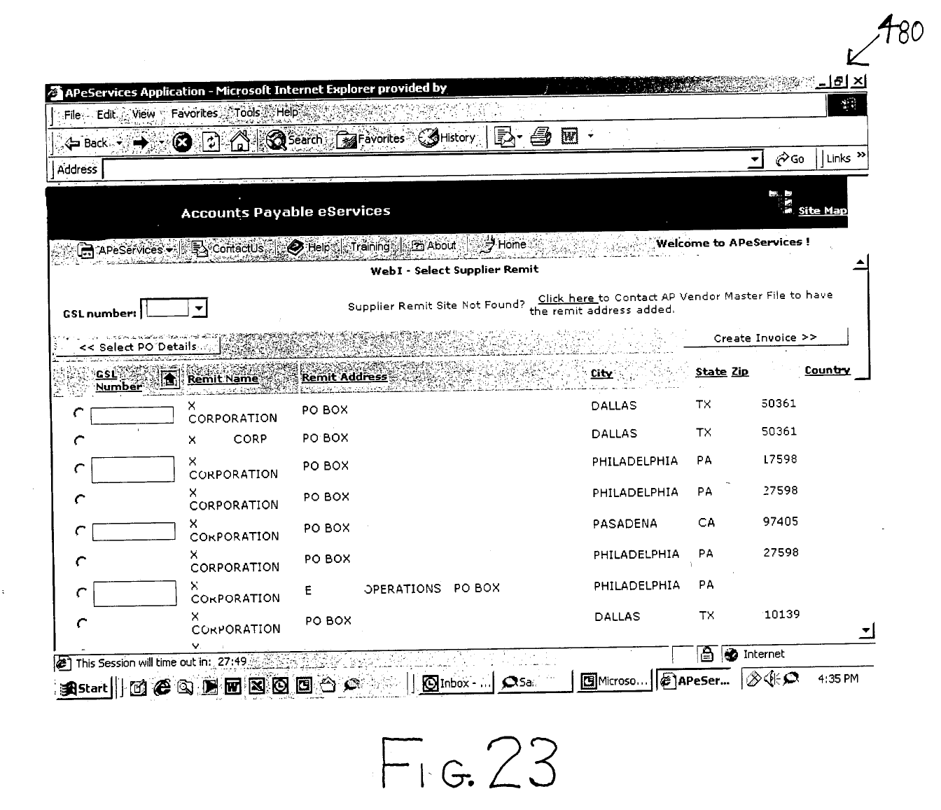

FIG. 23 is an example embodiment of a user interface 480 displaying a select supplier remit page within APCS 10 (shown in FIG. 1), which is displayed after a user selects the Select Remit To button displayed on user interface 470 (shown in FIG. 22). In the example embodiment, user interface 480 displays a GSL Number column, a Remit Name column, a Remit Address column, a City column, a State column, a Zip Code column, and a Country column. User interface 480 enables a user to enter a new Supplier or a new Remit To Address.

After a user selects a Supplier Remit Site Not Found link displayed on user interface 480, a pop-up window is displayed (not shown) which prompts the user to enter new vendor contact information. This information is then stored within APCS 10. After the information regarding the new vendor has been entered, a user selects a Create Invoice button to submit the information to APCS 10.

If, however, the specific Remit To Address is already in the APCS 10, then the user selects that particular Remit To Address entry and selects a Create Invoice button displayed on user interface 480.

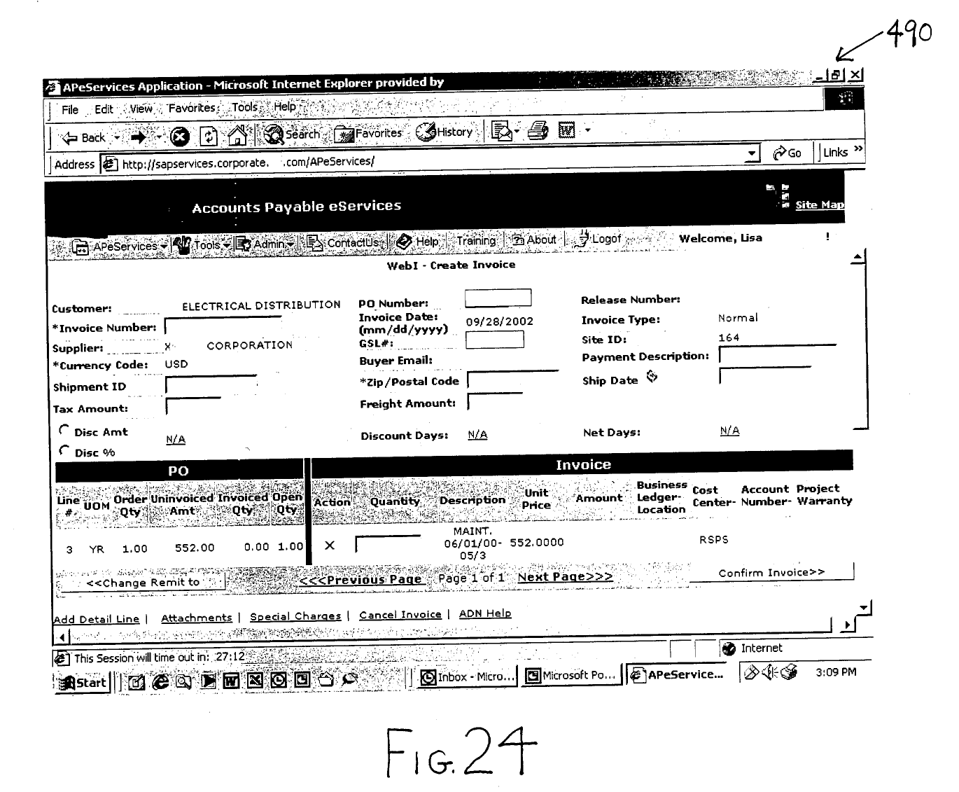

FIG. 24 is an example embodiment of a user interface 490 displaying a create invoice page within APCS 10 (shown in FIG. 1), which is displayed after a user selects a Remit To Address on user interface 480 (shown in FIG. 23) and clicks on the Create Invoice button. In the example embodiment, user interface 490 enables a user to create an invoice within APCS 10. User interface 490 displays at least one of an Invoice Number data field, a Payment Description data field, an Invoice Number data field, a Payment Description data field, a Tax Amount data field, a Freight Amount data field, a Discount Amount radio button, a PO section, and an Invoice section.

In the example embodiment, the information included in the Payment Description data field appears on a check stub used to pay the specific invoice. The type of tax to be applied to the transaction is entered in the Tax Amount data field. If tax is not required on an item, non-taxable will be displayed in the Tax Amount data field. If, however, the PO shows that an item it taxable and no tax amount is entered in the Tax Amount data field, APCS 10 will accrue a tax on the item. If an item is taxable and no tax amount is entered in the Tax Amount data field, a pop-up box will be displayed advising the user that the business will accrue the appropriate tax and remit it to the proper jurisdiction.

After the user has entered the requested information into user interface 490, the user clicks on a Confirm Invoice button to display a screen (not shown) that summarizes the Create Invoice information, which allows the user to review the information and confirm its accuracy. If the information requires modification, the invoice summary screen includes a Modify Invoice link which allows the user to modify the invoice information. In the example embodiment, the invoice summary screen also includes an Attachments link which allows the user to add attachments to the invoice.

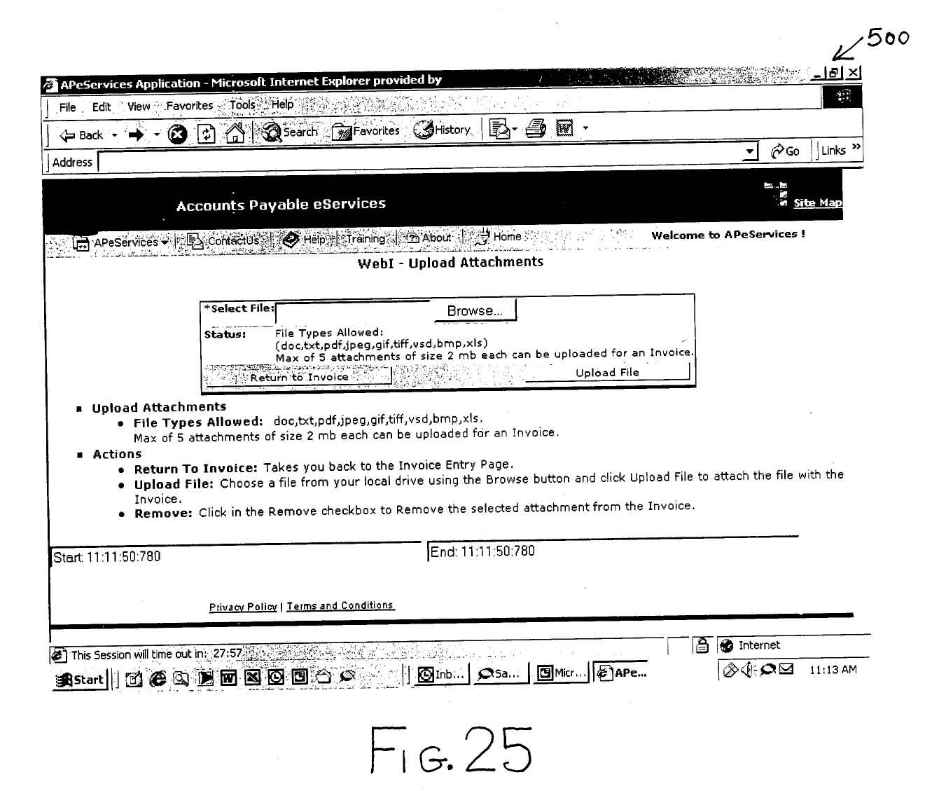

FIG. 25 is an example embodiment of a user interface 500 displaying an upload attachments page within APCS 10 (shown in FIG. 1), which allows a user to add an attachment to an invoice. In the example embodiment, user interface 500 includes a Select File data field and a Browse button. The Browse button enables a user to browse all files on the user's local computer drive. User interface 500 enables a user to select a file from the user's local computer drive using the Browse button and click on the Upload File to attach the file to a selected invoice. In the example embodiment, when a file has been attached to an invoice, the file will be displayed on user interface 500. After attaching the file to an invoice, the user may select a Return to Invoice button to return to the selected invoice.

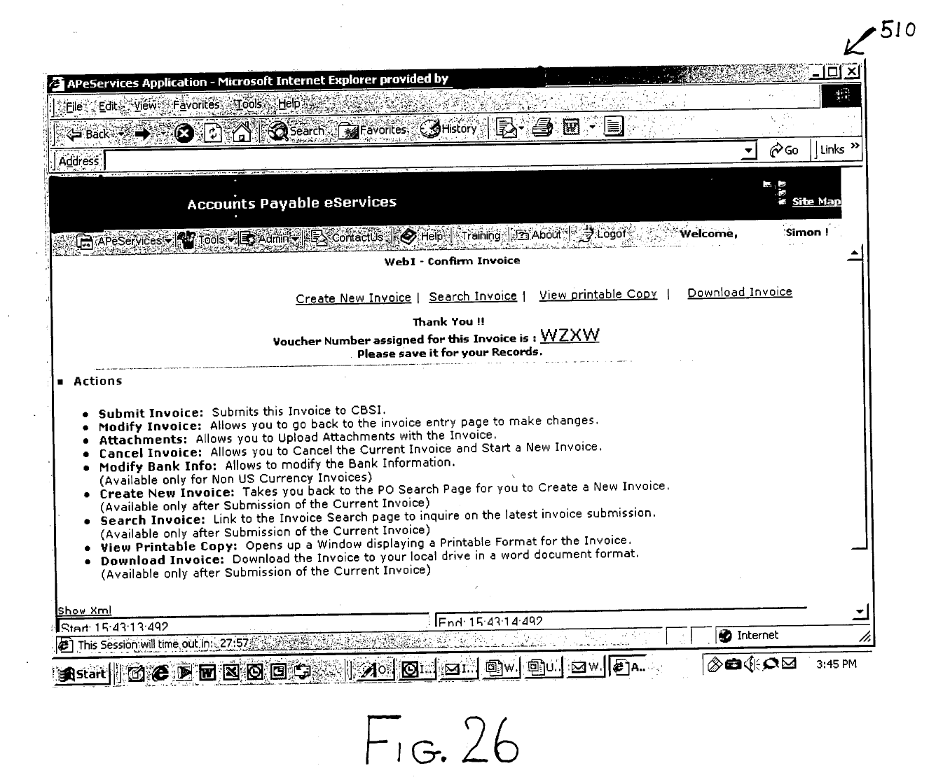

FIG. 26 is an example embodiment of a user interface 510 displaying a confirm invoice actions page within APCS 10 (shown in FIG. 1). In the example embodiment, user interface 510 displays a Create New Invoice link, a Search Invoice link, a View Printable Copy link, and a Download Invoice link. User interface 510 displays actions that a user can take within APCS 10 with respect to an invoice.

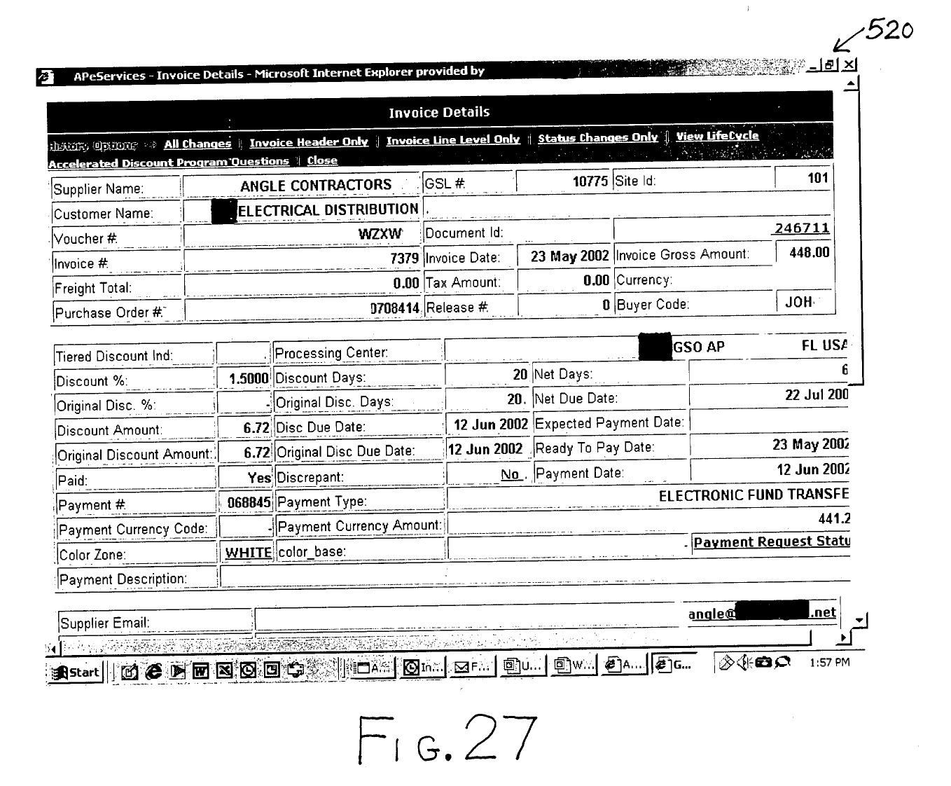

FIG. 27 is an example embodiment of a user interface 520 displaying an invoice details page within APCS 10 (shown in FIG. 1). User interface 520 displays detailed information relating to a selected invoice including at least one of a Supplier Name, a Customer Name, a Voucher Number, an Invoice Number, a Purchase Order Number, an Invoice Gross Amount, and a Discount Amount. In the example embodiment, user interface 520 may be converted into a printable invoice page, which may be utilized by a user as an invoice.

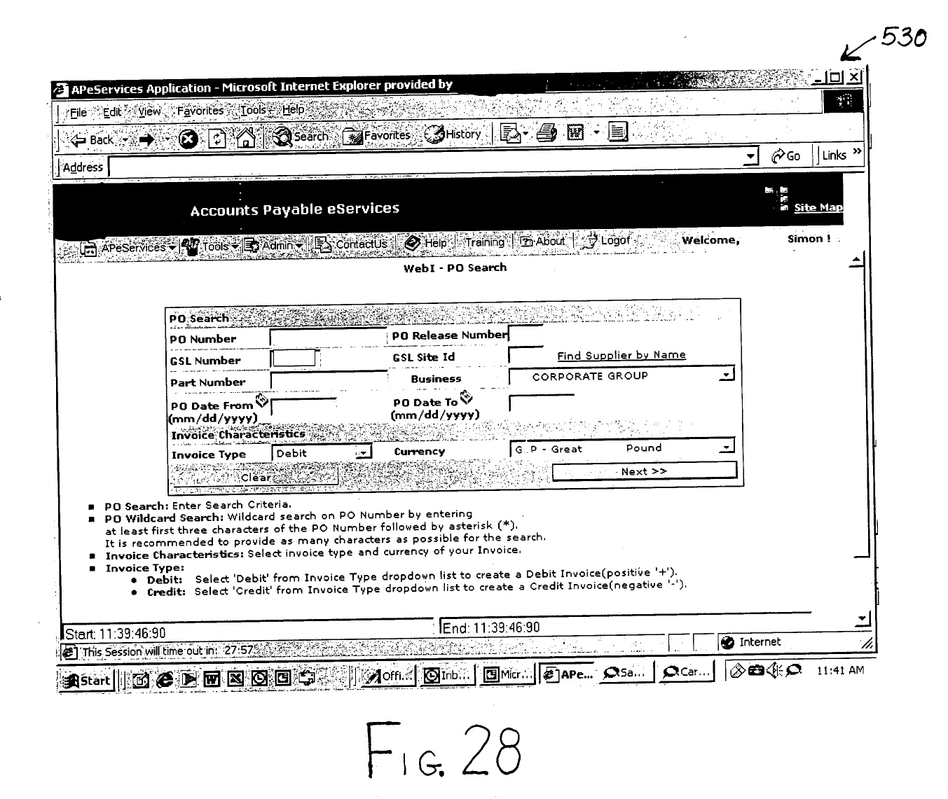

FIG. 28 is an example embodiment of a user interface 530 displaying a purchase order search page using non-U.S. currency within APCS 10 (shown in FIG. 1). User interface 530 is identical to user interface 450 (shown in FIG. 20) except that user interface 530 displays non-U.S. currency in the Currency pull-down list data field. In the example embodiment, depending upon the location of the buyer, APCS 10 will prompt a user as to whether certain taxes should be considered for invoicing purposes. For example, if a supplier is located in the United Kingdom, APCS 10 will prompt the user to consider whether a value added tax (i.e., VAT) should be included in the invoicing. Additionally, if a Supplier is located in Canada, APCS 10 will prompt the user to determine whether a Goods and Service Tax (i.e., GST) should be included in the invoice. Also, if a Supplier is located in Mexico, APCS 10 will provide IVA as a tax option. If such a tax is included, a data field will be displayed showing a special charge line.

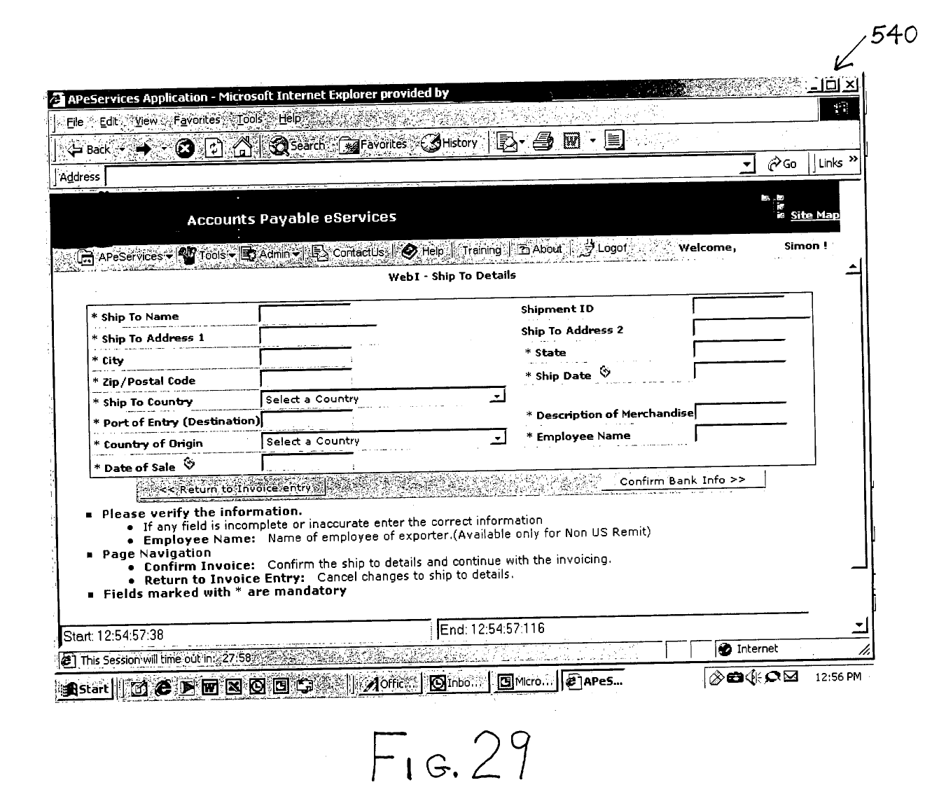

FIG. 29 is an example embodiment of a user interface 540 displaying a ship to details page within APCS 10 (shown in FIG. 1), which is displayed for items shipped from countries other than the United States for compliance reasons. In the example embodiment, user interface 540 includes a Ship To Name data field, a Ship To Address data field, a City data field, a Shipment ID data field, a Ship to Country pull-down field, and a Country of Origin pull-down field. The information entered through user interface 540 is required by U.S. Customs and is mandatory on all invoices where the Remit Site is other than the United States.

In the example embodiment, user interface 540 also includes a Confirmed Bank Info button, which, when selected, displays a pop-up screen that prompts the user to enter the required bank information for invoicing purposes. APCS 10 will then process the bank information and will verify that the information is correct.

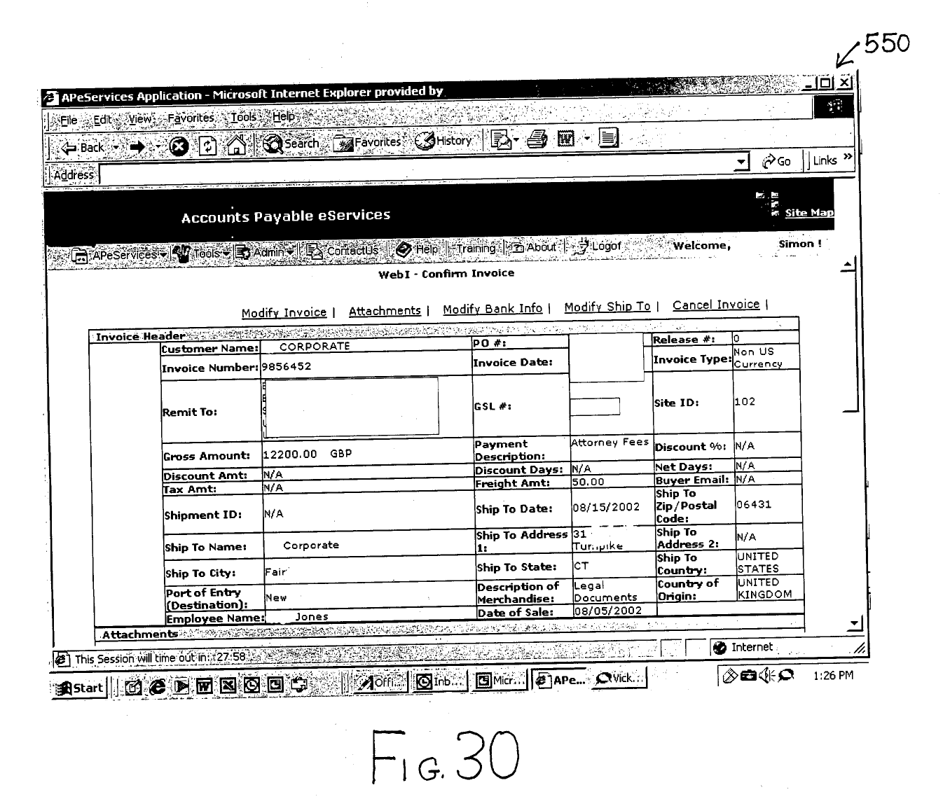

FIG. 30 is an example embodiment of a user interface 550 displaying a confirm invoice page within APCS 10 (shown in FIG. 1). User interface 550 enables a user to review and confirm the information entered for a specific invoice. User interface 550 also enables a user to modify the invoice information, modify the bank information, modify the ship to information, and cancel an invoice. Once the information has been confirmed by the user, the user selects a Submit Invoice button (not shown) to submit the information to APCS 10.

Payment Accelerator

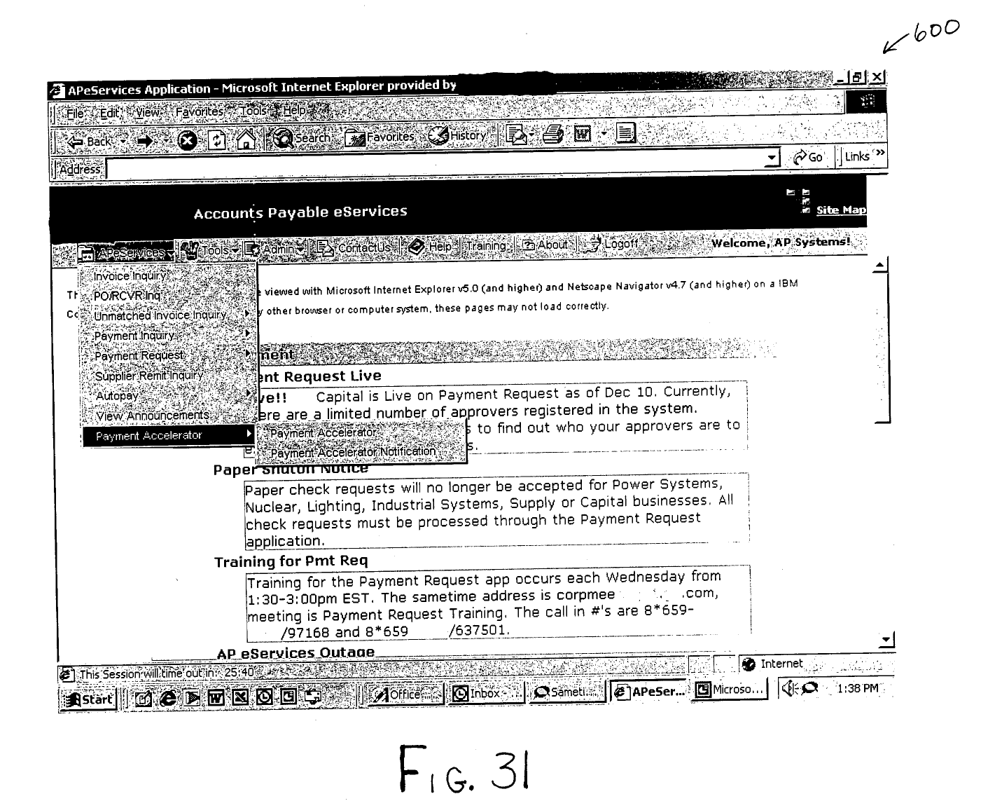

The APCS also includes a payment accelerator module. The Payment Accelerator module allows a user to expedite ready to pay invoices that satisfy a Payment Accelerator criteria while taking a discount for the early payment on these invoices. FIGS. 31 through 39 are example embodiments of user interfaces included within APCS 10 that relate to the Payment Accelerator.

FIG. 31 is a example embodiment of a user interface 600 displaying a common navigational bar having a Payment Accelerator function included within APCS 10 (shown in FIG. 1). The Payment Accelerator function displayed on user interface 600 is displayed when the user has been granted access to the Payment Accelerator module. The Payment Accelerator module is also known as a Payment Accelerator privilege. After a user has been approved for access to the Payment Accelerator privilege, the user has access to both the Payment Accelerator and a Payment Accelerator Notification function. The Payment Accelerator function allows a user to expedite ready to pay invoices meeting criteria eligibility while taking a discount on these early paid invoices. The Payment Accelerator Notification function allows a user to register a supplier or other user to receive notification based on the frequency selected whenever invoices satisfying the Payment Accelerator criteria are received within APCS 10.

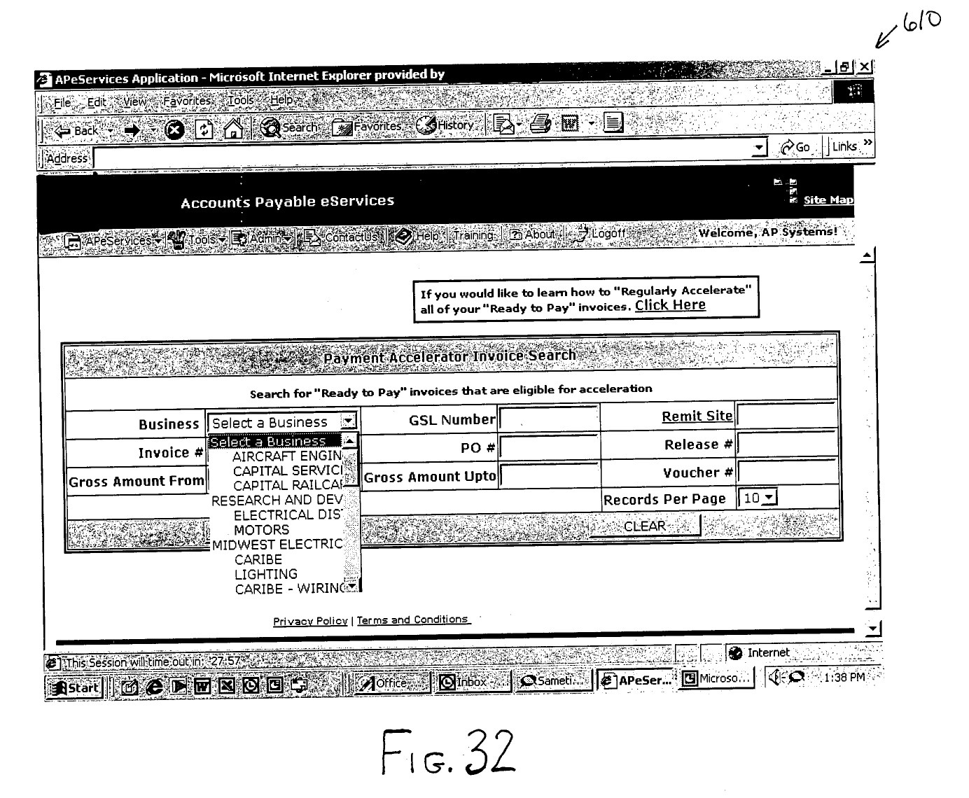

FIG. 32 is the-example embodiment of a user interface 610 displaying a payment accelerator invoice search page within APCS 10 (shown in FIG. 1), which is displayed when a user searches within APCS 10 for a ready to pay invoice. In the example embodiment, user interface 610 includes a Business pull-down list, an Invoice Number data field, a Gross Amount From data field, a GSL Number data field, a PO Number data field, a Gross Amount Up To data field, a Remit Site data field, a Release Number data field, and a Voucher Number data field. After the user enters the required information into user interface 610, the user selects a Continue button to display the search results.

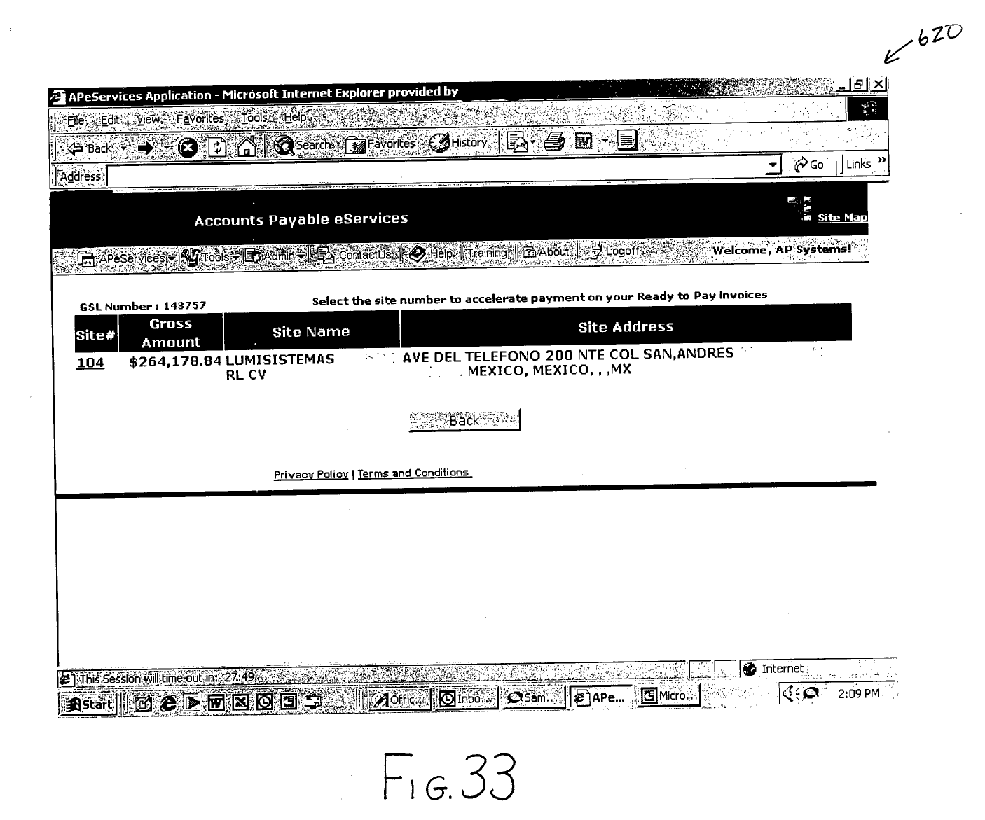

FIG. 33 is an example embodiment of a user interface 620 displaying search results from a payment accelerator invoice search performed within APCS 10 (shown in FIG. 1). In the example embodiment, user interface 620 includes a Site Number column, a Gross Amount column, a Site Name column, and a Site Address column. The gross amount displayed on user interface 620 in the gross amount eligible for payment acceleration.

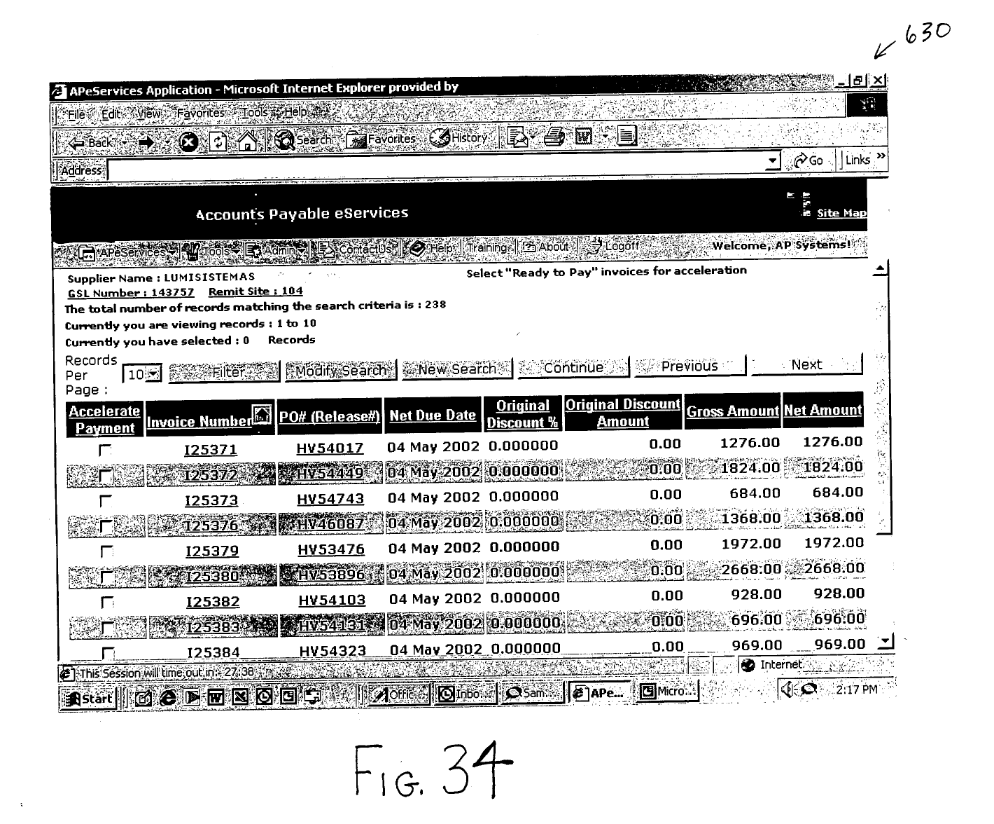

FIG. 34 is an example embodiment of a user interface 630 displaying multiple search results from a payment accelerator invoice search performed within APCS 10 (shown in FIG. 1). In the example embodiment, the search results displayed on user interface 630 are based on a GSL Number and a Remit Site. User interface 630 includes a Filter button, a Modify Search button, a New Search button, a Continue button, a Previous button, and a Next button. The Filter button enables a user to filter (i.e., narrow) the search results displayed. Using the Filter button, the user can drill-down on the specifications of the invoices being reviewed (i.e., view only those invoices over $1,000).

In the example embodiment, user interface 630 also displays an Accelerate Payment column, an Invoice Number column, a PO Number column, a Net Due Date column, an Original Discount Percentage column, an Original Discount Amount column, a Gross Amount column, and a Net Amount column. The user can select the invoice to be accelerated for payment by clicking on the check box under the Accelerate Payment column for the corresponding invoice. If selected for acceleration, the invoices will have the discount percentage and discount amount calculated later in the processing. After selecting the invoices to be accelerated, the user continues the process by clicking on the Continue button displayed on user interface 630. The accelerated invoices are then displayed for the user to review.

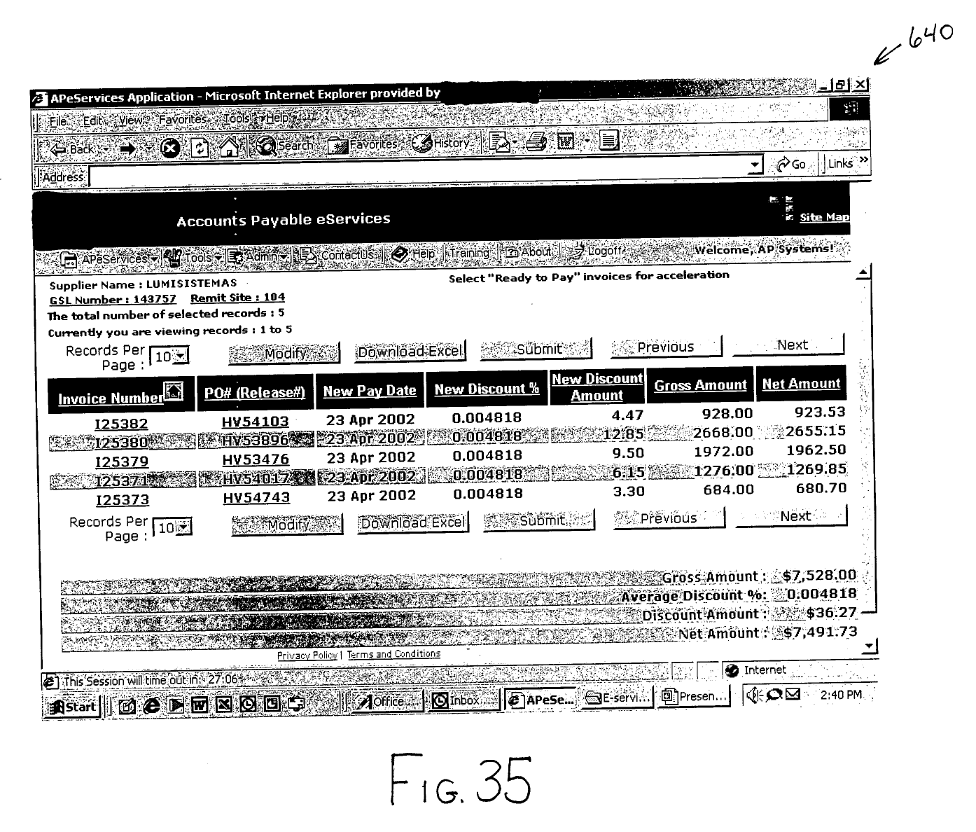

FIG. 35 is an example embodiment of a user interface 640 displaying invoices selected for acceleration within APCS 10 (shown in FIG. 1). User interface 640 is displayed after a user selects invoices to be accelerated on user interface 630 (shown in FIG. 34). In the example embodiment, user interface 640 includes an Invoice Number column, a PO Number column, a New Pay Date column, a New Discount Percentage column, a New Discount Amount column, a Gross Amount column, and a Net Amount column. User interface 640 also displays a Modify button, a Download Excel button, a Submit button, a Previous button, and a Next button.

The Modify button displayed on user interface 640 enables a user to modify the search performed to generate the displayed list of invoices. The Download Excel button enables a user to download all records selected to an Excel® spreadsheet. (Excel is a registered trademark of Microsoft Corporation, Redmond, Wash.). User interface 640 also displays the discount percentage and the discount amount to be taken on each invoice selected.

In the example embodiment, user interface 640 also displays a Gross Amount, an Average Discount Percentage, a Discount Amount, and a Net Amount for the listed invoices. After the user has reviewed the invoices selected, the user may click on the Submit button to continue with accelerating the payments.

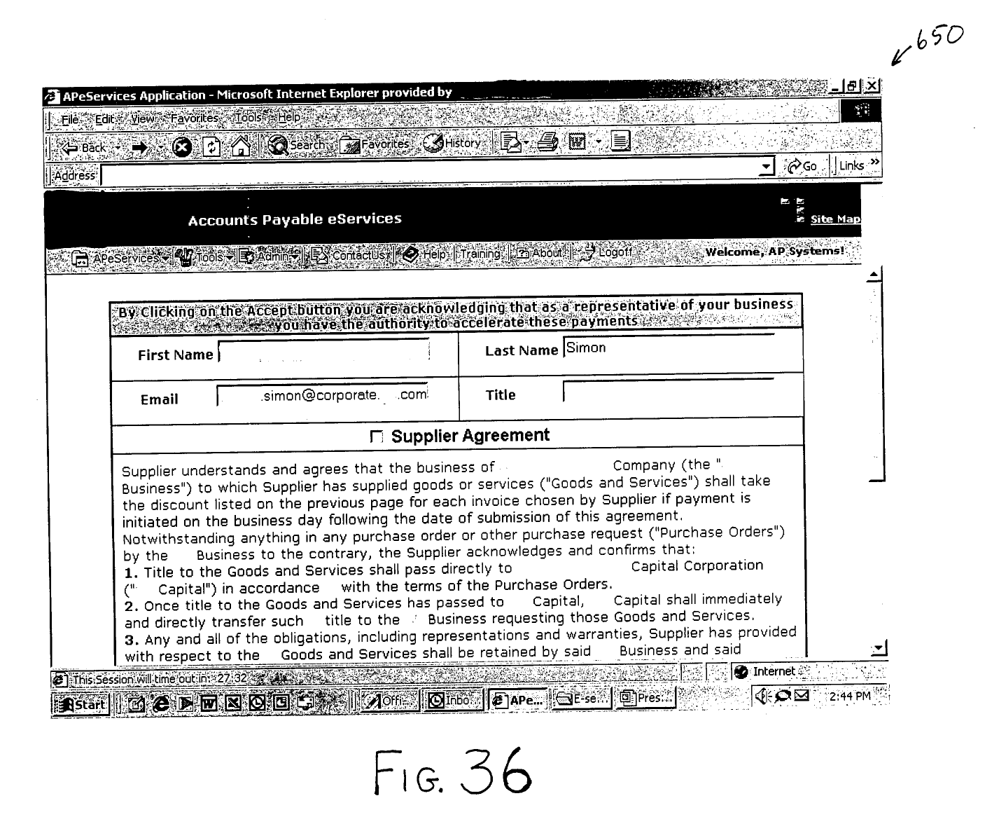

FIG. 36 is an example embodiment of user interface 650 displaying a supplier agreement page within APCS 10 (shown in FIG. 1), which is displayed after a user has selected invoices for payment acceleration. In the example embodiment, user interface 650 displays a Supplier Agreement that sets forth the terms and conditions for accelerating the payment of selected invoices. The Supplier Agreement has already been negotiated between the business and the specific supplier, and the terms and conditions generally agreed to by the parties. User interface 650 includes an Accept button (not shown) and a Close button (not shown). The Accept button enables a user to agree to the terms and conditions of the Supplier Agreement. By clicking on the Accept button, the user is acknowledging that as a representative of the business the user has the authority to accelerate for payment the selected invoices. If, however, the user clicks on the Close button, APCS 10 returns the user to the previous screen. If the user selects the Accept button, APCS 10 processes the request for accelerated payment and provides the user with a summary of the invoices processed. In the example embodiment, APCS 10 also enables a user to apply a credit to an invoice and accelerate payment on that particular invoice.

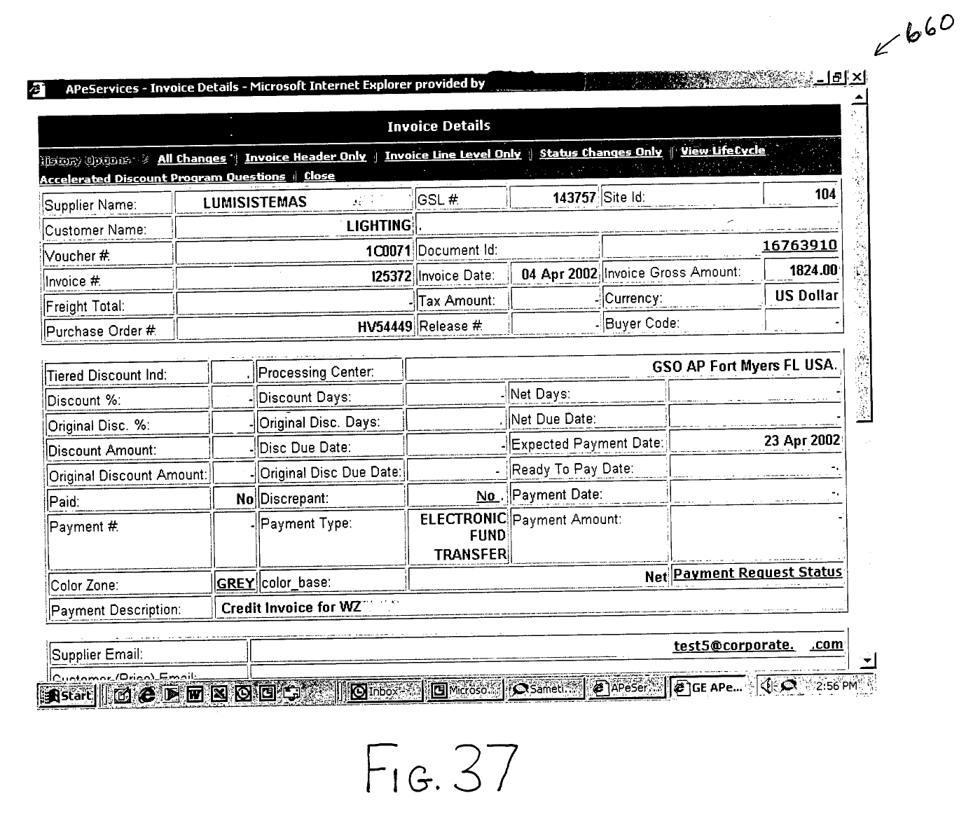

FIG. 37 is an example embodiment of a user interface 660 displaying an invoice details page for an invoice included within APCS 10 (shown in FIG. 1). User interface 660 includes a credit invoice displayed in the Payment Description data field.

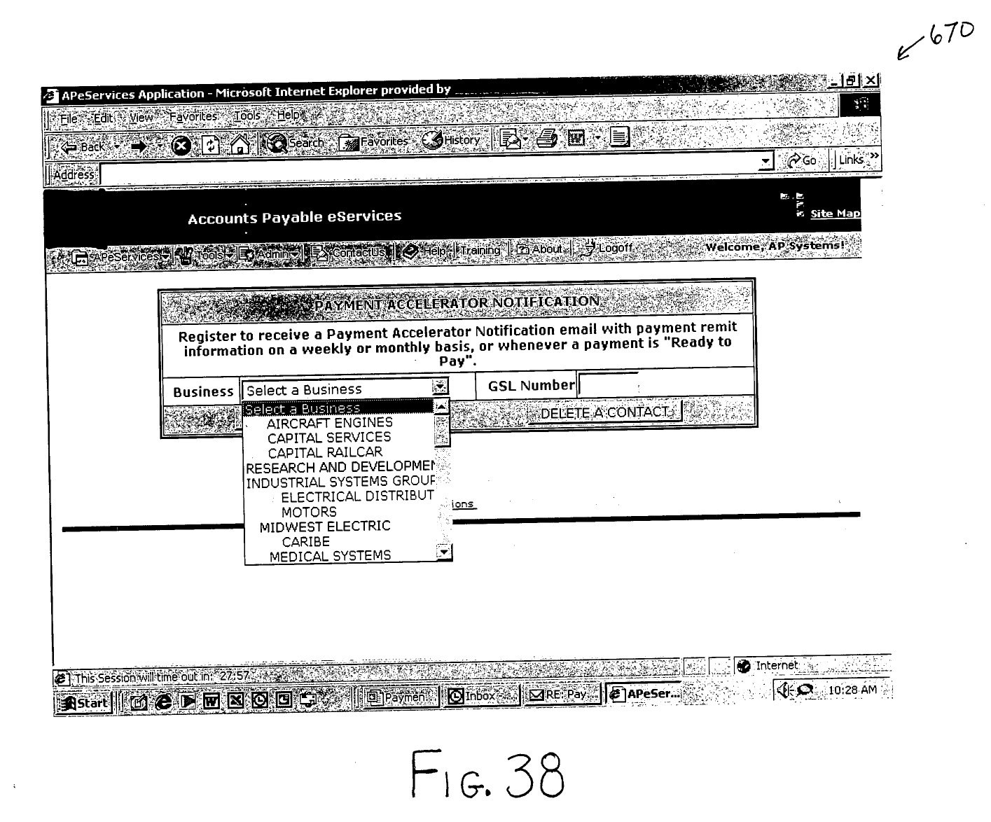

FIG. 38 is an example embodiment of a user interface 670 displaying a payment accelerator notification page within APCS 10 (shown in FIG. 1), which is displayed after a user selects the Payment Accelerator Notification function displayed on user interface 600 (shown in FIG. 31). The Payment Accelerator Notification function allows a user to sign up a supplier or a user to receive notification based on a frequency selected whenever invoices satisfying a Payment Accelerator Criteria are received by APCS 10. In the example embodiment, user interface 670 displays a Business pull-down list and a GSL Number data field.

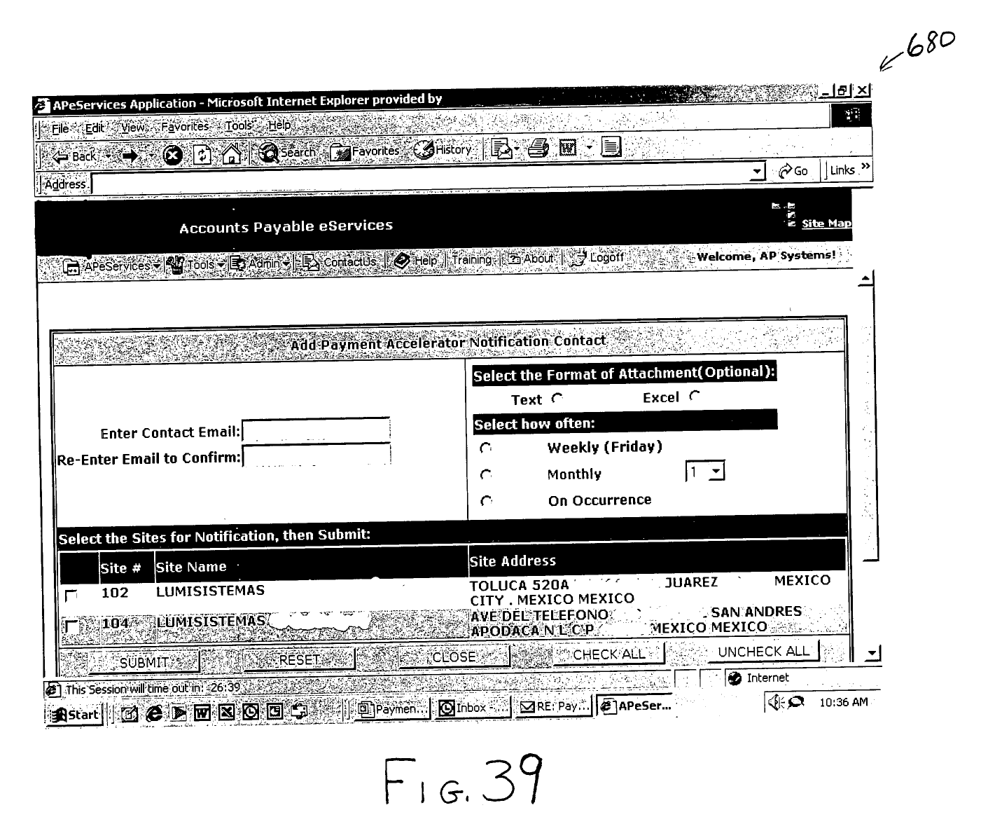

FIG. 39 is an example embodiment of a user interface 680 displaying an add payment accelerator notification contact page within APCS 10 (shown in FIG. 1). In the example embodiment, user interface 680 includes an Enter Contact E-mail data field, a Select the Format of Attachment section, a Select How Often section, and a Select the Sites for Notification section. User interface 680 enables a user to select a person to receive notification of invoices received by APCS 10 that satisfy the Payment Accelerator Criteria. User interface 680 also enables a user to select a frequency for receiving such notifications. APCS 10 also enables a user to select a supplier to receive a payment accelerator notification, and enables a user to delete a contact person from receiving a payment accelerator notification.

Payment Inquiry Search and Notification

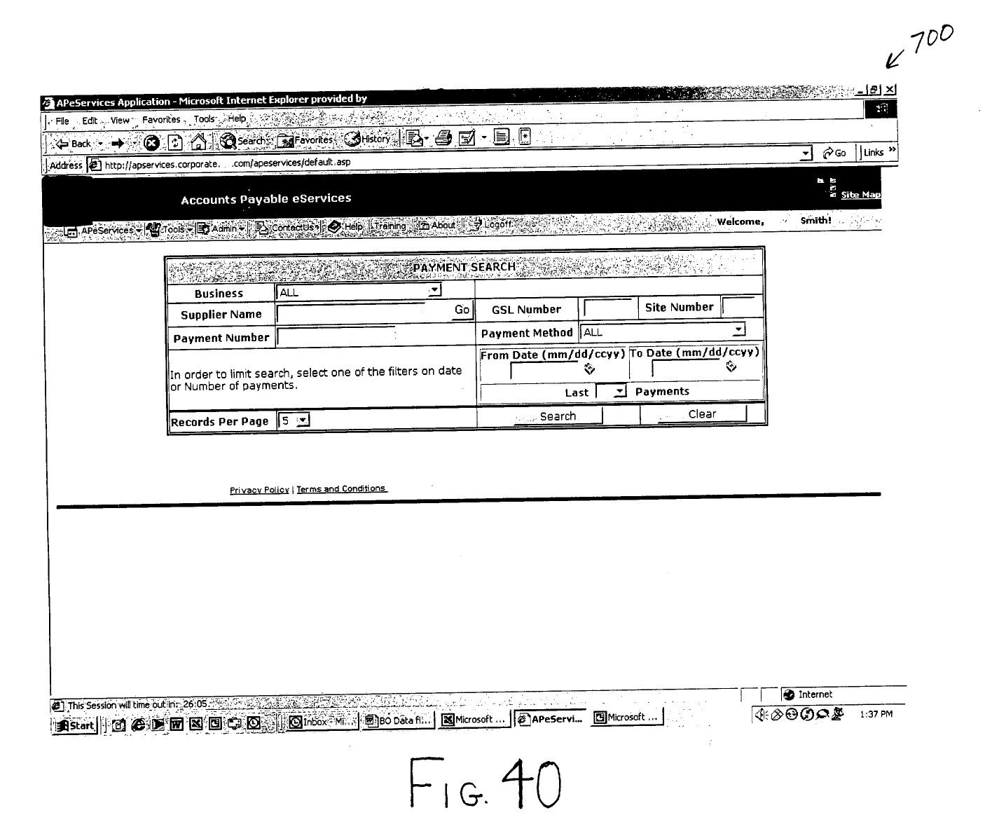

The APCS also enables authorized users to search and review payment information, and receive notification as to when payments are made through APCS. FIGS. 40 through 43 are example embodiments of user interfaces included within APCS 10 that relate to the review of payment information and the receipt of payment notifications.

FIG. 40 is an example embodiment of a user interface 700 displaying a payment search page within APCS 10 (shown in FIG. 1), which is displayed after a user selects a Payment Search function. In the example embodiment, user interface 700 includes a Business pull-down list, a Supplier Name data field with a corresponding Go button, a Payment Number data field, a GSL Number data field, a Site Number data field, a Payment Method pull-down list, a From Date data field, and a To Date data field. The From Date data field and the To Date data field also include a corresponding calendar icon, which enables the user to display a calendar to select the appropriate dates to be entered into the data fields. User interface 700 also includes a Search button, and a Clear button. After the user enters the requested information, the user clicks on the Search button to conduct the search within APCS 10.

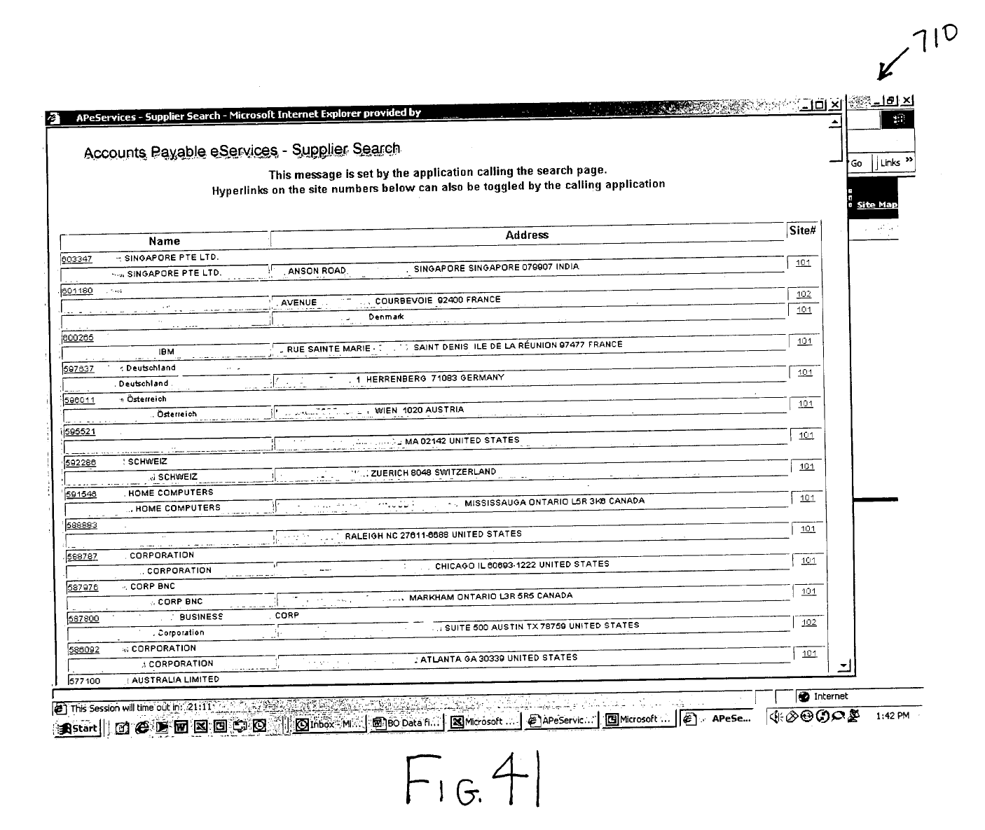

FIG. 41 is an example embodiment of a user interface 710 displaying a supplier search result page within APCS 10 (shown in FIG. 1). In the example embodiment, user interface 710 displays a Supplier Name, an Address for the Supplier, and a Site Number.

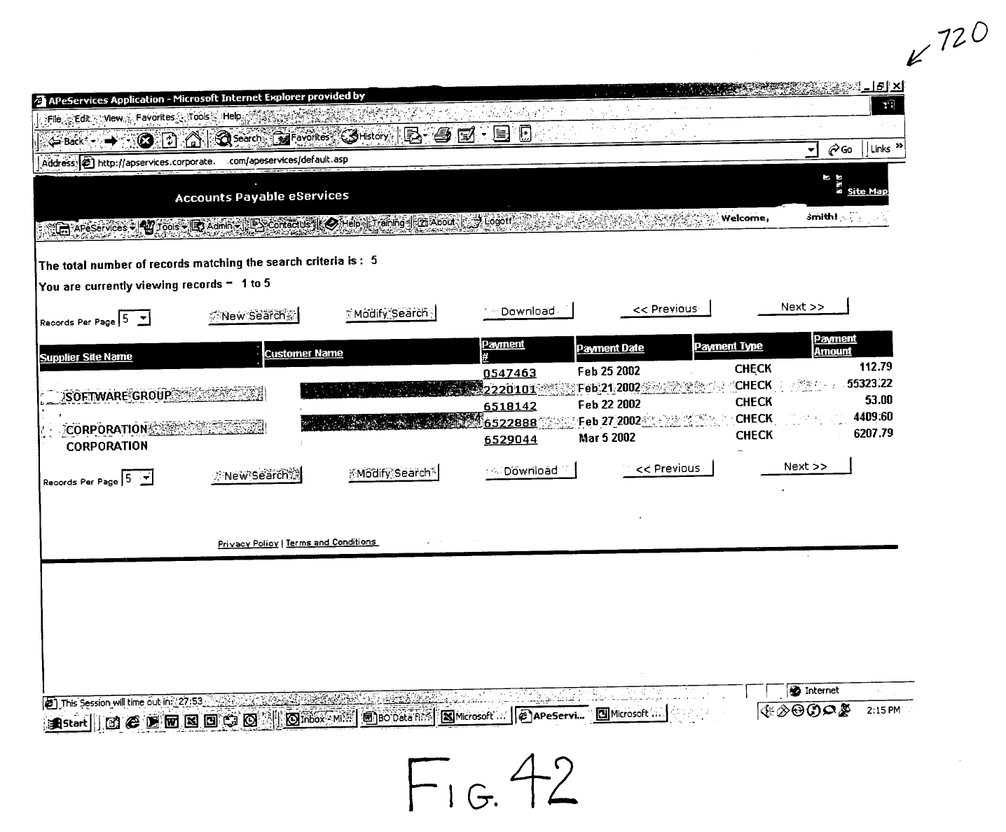

FIG. 42 is an example embodiment of a user interface 720 displaying a payment search result page within APCS 10 (shown in FIG. 1), which is displayed after a user conducts a payment search within APCS 10. In the example embodiment, user interface 720 includes the following information: a Supplier Site Name, a Customer Name, a Payment Number, a Payment Date, a Payment Type, and a Payment Amount. User interface 720 also includes a New Search button, a Modify Search button, a Download button, a Previous button, and a Next button. In the example embodiment, information displayed on user interface 720 my clicked on to display additional supporting information. For example, when a user clicks on a Payment Number shown on user interface 720, the details of that payment will open in a new window. The new window displays the additional information including at least one of a Shipment ID (i.e., bill of lading), Invoices Settled by the Payment, Purchase Orders associated with the Payment, Voucher Numbers associated with the Payment, a Payment Description, a Gross Amount of the Invoices, a Discount Amount, and a Paid Amount.

User interface 720 also enables a user to download the payment details by using the download button. By selecting the download button, a user may download the payment details to a Microsoft Excels file, which can then be printed.

In the example embodiment, information displayed in the additional detail windows may also be clicked on by the user to further display additional supporting documentation. For example, a user may click on a Voucher Number to view an image of the original or pro forma invoice. Additionally, a user may click on the Invoice Number to view the specific invoice details.

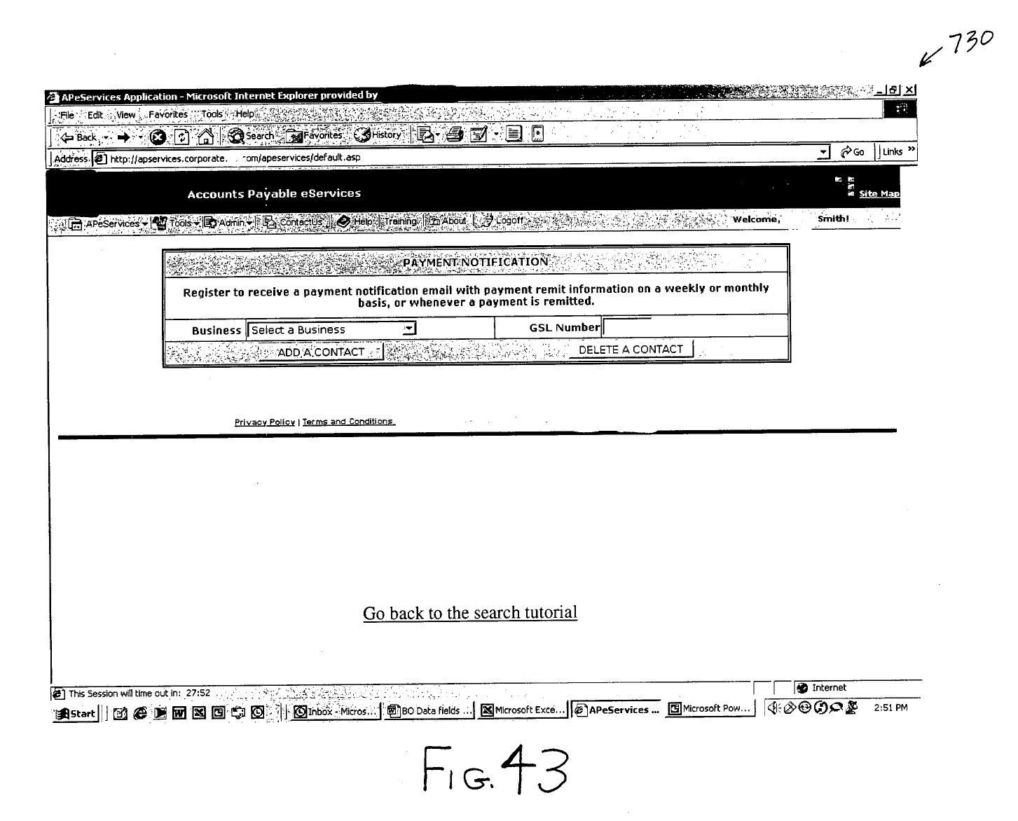

FIG. 43 is an example embodiment of user interface 730 displaying a payment notification page within APCS 10 (shown in FIG. 1). In the example embodiment, user interface 730 includes a Business pull-down list, a GSL Number data field, an Add A Contact button, and a Delete A Contact button. User interface 730 enables a user to register a supplier to automatically receive remittance details via e-mail. The user adds the supplier through an Add Payment Notification Contact page (not shown) which prompts the user to select the format of attachment to be sent to the supplier and how often the supplier is to receive the notification. The user is also enabled to delete a contact from the payment notification function.

APCS therefore better enables a business having accounts payable to register within the system, and then collect, manage, store and disseminate accounts payable (AP) information among internal users and selected outside users to facilitate a more accurate and efficient processing of accounts payable for that specific business. In the example embodiment, the APCS collects, tracks, displays, and disseminates near-real time AP information. In addition, the APCS permits various approved users within the business to share AP information. The APCS also enables approved users to input invoices, process invoices, match invoices with purchase orders, approve invoices for payment, pay invoices, confirm the payment of invoices, and request and receive payment notifications at specified intervals. In addition, the APCS enables a user to manage appropriate write-offs and reporting capabilities. Furthermore, the APCS enables a user to accelerate payment of selected invoices so as to receive a discount for expedited payment of invoices, and manage the payment accelerator notification for future ready to pay transactions with which expedited payments could be made.

While the invention has been described in terms of various specific embodiments, those skilled in the art will recognize that the invention can be practiced with modification within the spirit and scope of the claims.

What is claimed is:

1. A method for managing accounts payable for a business using a server system coupled to a centralized database and at least one client system, said method comprising:
receiving at the server system accounts payable (AP) information for the business from the client system, AP information includes at least one of invoices and purchase orders relating to the business;
storing the AP information received at the server system in the centralized database;
authorizing a user to access the AP information based on a profile of the user;
updating the centralized database periodically with newly received AP information to maintain the AP information;
processing the AP information stored in the centralized database; and
utilizing a payment accelerator module to facilitate expedited payment of invoices satisfying a payment accelerator criteria.

2. A method in accordance with claim 1 wherein authorizing a user to access the AP information further comprises:
prompting a user to enter a profile of the user including at least one of a user name, a user e-mail address, a user ID, a department within the business that the user works for, and contact information for the user;
transmitting from the user to an approver a request for access to AP information relating to at least one department within the business; and
transmitting from the user to an approver a request for access to at least one module included within the server system, the server system includes at least one of an invoice inquiry module, a purchase order/receiver inquiry module, an unmatched invoice inquiry module, a payment inquiry module, an autopay module, a payable process information module, and a payment request submission module.

3. A method in accordance with claim 2 further comprising:
reviewing the user's request for access to AP information relating to at least one department within the business and at least one module included within the server system; and
granting or denying the user's request for access to AP information relating to at least one department within the business and the user's request for access to at least one module included within the server system.

4. A method in accordance with claim 3 further comprising:
transmitting a notification from the approver to the user advising the user as to whether the user has been granted or denied access to AP information for each department within the business where the user has requested access and each module included within the server system where the user has requested access.

5. A method in accordance with claim 1 wherein processing the AP information stored in the centralized database further comprises enabling a user to submit from the client system to the server system at least one invoice for processing and payment.

6. A method in accordance with claim 1 wherein processing the AP information stored in the centralized database further comprises:
enabling a user to search at the client system for at least one purchase order by at least one of a purchase order number, a GSL number, a part number, a purchase order date from to purchase order date to entry, a purchase order release number, a GSL site ID, an invoice type, and a currency type.

7. A method in accordance with claim 1 wherein receiving at the server system AP information for the business from the client system further comprises:
prompting a user to create an invoice at the client system;
attaching a computer file to the invoice; and
transmitting the invoice and the computer file attached thereto from the client system to the server system.

8. A method in accordance with claim 1 wherein utilizing a payment accelerator module further comprises:
prompting a user at the client system to select at least one invoice from a supplier for accelerated payment;
utilizing the payment accelerator module to determine whether the selected invoice satisfies a payment accelerator criteria; and
if the selected invoice satisfies the payment accelerator criteria, calculating at the payment accelerator module a discount percentage and a discount amount for the selected invoice based on the terms of a supplier agreement entered into between the business and the supplier.

9. A method in accordance with claim 1 wherein utilizing a payment accelerator module further comprises exporting at least one invoice satisfying a payment accelerator criteria to a spreadsheet computer program for review and further processing.

10. A method in accordance with claim 1 further comprising displaying a payment accelerator notification page on the client system for prompting a user to register at least one of a supplier and a user to receive notification based on a frequency selected of when at least one invoice satisfying a payment accelerator criteria is received at the server system.

11. A method in accordance with claim 1 further comprising displaying a payment notification page on the client system for notifying at least one of a user and a supplier that a payment has been made relating to an invoice satisfying a payment criteria.

12. A method in accordance with claim 1 wherein processing the AP information stored in the centralized database further comprises:
accessing the centralized database;
searching the database regarding a specific inquiry;
retrieving information from the database; and
transmitting the retrieved information -to the client system for display by the client system.

13. A method in accordance with claim 1 further comprising connecting the client system and the server system via a network that includes one of a wide area network, a local area network, an intranet and the Internet.

14. A method for managing accounts payable for a business using a server system coupled to a centralized database and at least one client system, said method comprising:
receiving at the server system accounts payable (AP) information for the business from the client system, AP information includes at least one of invoices and purchase orders relating to the business;
storing the AP information received at the server system in the centralized database;
authorizing a user to access the AP information based on a profile of the user;
updating the centralized database periodically with newly received AP information to maintain the AP information;
processing the AP information stored in the centralized database including enabling a user to submit from the client system to the server system at least one invoice for processing and payment;
utilizing a payment accelerator module to facilitate expedited payment of invoices satisfying a payment accelerator criteria;
providing a payment accelerator notification page displayed on the client system for prompting a user to register at least one of a supplier and a user to receive notification based on a frequency selected of when at least one invoice satisfying the payment accelerator criteria is received at the server system; and
providing a payment notification page displayed on the client system for notifying at least one of a user and a supplier that a payment has been made relating to an invoice satisfying a payment criteria.

15. A method in accordance with claim 14 wherein authorizing a user to access the AP information further comprises:
prompting a user to enter a profile of the user including at least one of a user name, a user e-mail address, a user ID, a department within the business that the user works for, and contact information for the user;
transmitting from the user to an approver a request for access to AP information relating to at least one department within the business and a request for access to at least one module included within the server system, the server system includes at least one of an invoice inquiry module, a purchase order/receiver inquiry module, an unmatched invoice inquiry module, a payment inquiry module, an autopay module, a payable process information module, and a payment request submission module;
reviewing the user's request for access to AP information relating to at least one department within the business and at least one module included within the server system; and
granting or denying the user's request for access to AP information relating to at least one department within the business and the user's request for access to at least one module included within the server system.

16. A method in accordance with claim 15 further comprising:
transmitting a notification from the approver to the user advising the user as to whether the user has been granted or denied access to AP information for each department within the business where the user has requested access and each module included within the server system where the user has requested access.

17. A method in accordance with claim 14 wherein utilizing a payment accelerator module further comprises:
prompting a user at the client system to select at least one invoice from a supplier for accelerated payment;
utilizing the payment accelerator module to determine whether the selected invoice satisfies a payment accelerator criteria; and
if the selected invoice satisfies the payment accelerator criteria, calculating at the payment accelerator module a discount percentage and a discount amount for the selected invoice based on the terms of a supplier agreement entered into between the business and the supplier.

18. A method in accordance with claim 14 further comprising connecting the client system and the server system via a network that includes one of a wide area network, a local area network, an intranet and the Internet.

19. A network based system for managing accounts payable for a business, said system comprising:
a client system comprising a browser;
a centralized database for storing information; and
a server system configured to be coupled to said client system and said database, said server system further configured to:
receive accounts payable (AP) information for the business from said client system, wherein AP information includes at least one of invoices and purchase orders relating to the business;
store the AP information in the centralized database;
authorize a user to access the AP information based on a profile of the user;
update the centralized database periodically with newly received AP information to maintain the AP information;
process the AP information stored in the centralized database; and
access a payment accelerator module to facilitate expedited payment of invoices satisfying a payment accelerator criteria.

20. A system in accordance with claim 19 wherein said client system further comprises at least one of:
a displaying component for displaying at least one of a pull-down list, a data field, a check box, and hypertext link options relating to AP information;
a sending component to send an inquiry to said server system so that said server system can process and download the requested information to said client system;
a collection component for collecting AP information from users into the centralized database;
a tracking component for tracking AP information;
a displaying component for displaying AP information;
a receiving component for receiving an inquiry from said client system regarding at least one of a purchase order number, a GSL number, a part number, a purchase order date from and a purchase order date to, a purchase order release number, a GSL site ID, an invoice type, and a currency type;
an accessing component for accessing the centralized database and causing the retrieved information to be displayed on said client system; and
a notifying component for electronically notifying an approver that a user requests access to AP information relating to at least one department within the business and to at least one module included within said server system.

21. A system in accordance with claim 19 wherein said server system is further configured to receive an inquiry to provide information from one of a plurality of users.

22. A system in accordance with claim 19 wherein said server system further comprises at least one of an invoice inquiry module, a purchase order/receiver inquiry module, an unmatched invoice inquiry module, a payment inquiry module, an autopay module, a payable process information module, and a payment request submission module.

23. A system in accordance with claim 19 wherein said server system is further configured to:
prompt a user to enter a profile of the user including at least one of a user name, a user e-mail address, a user ID, a department within the business that the user works for, and contact information for the user;
transmit from the user to an approver a request for access to AP information relating to at least one department within the business; and
transmit from the user to an approver a request for access to at least one module included within said server system, said server system includes at least one of an invoice inquiry module, a purchase order/receiver inquiry module, an unmatched invoice inquiry module, a payment inquiry module, an autopay module, a payable process information module, and a payment request submission module.

24. A system in accordance with claim 23 wherein said server system is further configured to:
enable an approver to grant or deny the user's request for access to AP information relating to at least one department within the business and the user's request for access to at least one module included within said server system.

25. A system in accordance with claim 24 wherein said server system is further configured to:
transmit a notification from the approver to the user advising the user as to whether the user has been granted or denied access to AP information for each department within the business where the user has requested access and each module included within said server system where the user has requested access.

26. A system in accordance with claim 19 wherein said server system is further configured to prompt a user to submit from said client system at least one invoice for processing and payment.

27. A system in accordance with claim 19 wherein said server system is further configured to:
receive from a client system a search inquiry relating to at least one purchase order for the business wherein said inquiry includes at least one of a purchase order number, a GSL number, a part number, a purchase order date from to purchase order date to entry, a purchase order release number, a GSL site ID, an invoice type, and a currency type; and
access the centralized database and retrieve AP information satisfying the search inquiry.

28. A system in accordance with claim 19 wherein said server system is further configured to:
enable a user to create an invoice at said client system;
enable a user to attach a computer file to said invoice; and
receive the invoice and the computer file attached thereto from said client system.

29. A system in accordance with claim 19 wherein said server system is further configured to:
prompt a user to select at least one invoice from a supplier for accelerated payment;
access the payment accelerator module to determine whether the selected invoice satisfies a payment accelerator criteria; and
if the selected invoice satisfies the payment accelerator criteria, access the payment accelerator module to calculate a discount percentage and a discount amount for the selected invoice based on the terms of a supplier agreement entered into between the business and the supplier.

30. A system in accordance with claim 19 wherein said server system is further configured to export at least one invoice satisfying a payment accelerator criteria to a spreadsheet computer program for review and further processing.

31. A system in accordance with claim 19 wherein said server system is further configured to display a payment accelerator notification page on a client system for prompting a user to register at least one of a supplier and a user to receive notification based on a frequency selected of when at least one invoice satisfying a payment accelerator criteria is received.

32. A system in accordance with claim 19 wherein said server system is further configured to display a payment notification page on a client system for notifying at least one of a user and a supplier that a payment has been made relating to an invoice satisfying a payment criteria.

33. A system in accordance with claim 19 further comprising a communication link between said server system and said client system, wherein said communication link includes at least one of a wide area network, a local area network, an intranet and the Internet.

34. A computer program embodied on a computer readable medium for managing accounts payable for a business, said program comprising a code segment that receives accounts payable (AP) information for the business and then:
maintains a database by adding, deleting and updating AP information wherein AP information includes at least one of invoices and purchase orders relating to the business;
provides users with access to AP information;
authorizes users to access AP information based on a profile of the user;
processes AP information stored in the database; and
utilizes a payment accelerator module to facilitate expedited payment of invoices satisfying a payment accelerator criteria.

35. A computer program in accordance with claim 34 further comprising a code segment that:
prompts a user to enter a profile of the user including at least one of a user name, a user e-mail address, a user ID, a department within the business that the user works for, and contact information for the user;
transmits from the user to an approver a request for access to AP information relating to at least one department within the business; and
transmits from the user to an approver a request for access to at least one of an invoice inquiry module, a purchase order/receiver inquiry module, an unmatched invoice inquiry module, a-payment inquiry-module, an autopay module, a payable process information module, and a payment request submission module.

36. A computer program in accordance with claim 35 further comprising a code segment that:
provides an approver with the user's request for access to AP information relating to at least one department within the business and at least one of the invoice inquiry module, the purchase order/receiver inquiry module, the unmatched invoice inquiry module, the payment inquiry module, the autopay module, the payable process information module, and the payment request submission module; and
enables the approver to grant or deny the user's request for access to AP information relating to at least one department within the business and the user's request for access to at least one of the invoice inquiry module, the purchase order/receiver inquiry module, the unmatched invoice inquiry module, the payment inquiry module, the autopay module, the payable process information module, and the payment request submission module.

37. A computer program in accordance with claim 36 further comprising a code segment that transmits a notification from the approver to the user advising the user as to whether the user has been granted or denied access to AP information for each department within the business where the user has requested access and each module where the user has requested access.

38. A computer program in accordance with claim 34 further comprising a code segment that enables a user to submit at least one invoice for processing and payment.

39. A computer program in accordance with claim 34 further comprising a code segment that enables a user to search for at least one purchase order by at least one of a purchase order number, a GSL number, a part number, a purchase order date from to purchase order date to entry, a purchase order release number, a GSL site ID, an invoice type, and a currency type.

40. A computer program in accordance with claim 34 further comprising a code segment that:
prompts a user to create an invoice;
enables the user to attach a computer file to the invoice; and
transmits the invoice and the computer file attached thereto for processing and payment.

41. A computer program in accordance with claim 34 further comprising a code segment that:
prompts a user to select at least one invoice from a supplier for accelerated payment;
accesses the payment accelerator module to determine whether the selected invoice satisfies a payment accelerator criteria; and
if the selected invoice satisfies the payment accelerator criteria, utilizes the payment accelerator module to calculate a discount percentage and a discount amount for the selected invoice based on the terms of a supplier agreement entered into between the business and the supplier.

42. A computer program in accordance with claim 34 further comprising a code segment that generates a payment accelerator notification page that prompts a user to register at least one of a supplier and a user to receive notification based on a frequency selected of when at least one invoice satisfying a payment accelerator criteria is received.

43. A computer program in accordance with claim 34 further comprising a code segment that generates a payment notification page that notifies at least one of a user and a supplier that a payment has been made relating to an invoice satisfying a payment criteria.

44. A computer program in accordance with claim 34 further comprising a code segment that monitors the security of the system by restricting access to authorized individuals.
